(19) United States
(12) Patent Application Publication
(10) Pub. No.: US 2007/0093655 A1
(43) Pub. Date: Apr. 26, 2007

(54) Method for producing cellulose acylate, cellulose acylate film, and polarizer, retardation film, optical film and liquid-crystal display device comprising the film

(75) Inventor: Toyohisa Oya, Minami-Ashigara-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/583,003

(22) Filed: Oct. 19, 2006

(30) Foreign Application Priority Data
Oct. 21, 2005 (JP) 2005-306513
Jul. 31, 2006 (JP) 2006-208738

(51) Int. Cl. C08B 3/22

(52) U.S. Cl. 536/76

(57) ABSTRACT

A method for producing a cellulose acylate having a predetermined substitution degrees, which comprises acylating cellulose with an esterifying agent that contains an excessive amount of an acid anhydride relative to the hydroxyl group of cellulose, and mixing the reaction mixture with a water-containing reaction stopper to thereby hydrolyze the acid anhydride while controlling the temperature of the reaction mixture to fall between −30° C. and 35° C.

### BACKGROUND OF THE INVENTION

1. Field of the Invention

The present invention relates to a method for producing a cellulose acylate which has a high mean molecular weight and contains few minor impurities and which is suitable to optical films. Further, the invention relates to a cellulose acylate film formed of the cellulose acylate, and to a high-quality polarizer, retardation film, optical film and liquid-crystal display device comprising that film.

2. Description of the Related Art

Having transparency, toughness and optical anisotropy, cellulose acetate has been used as supports for photographic materials, and recently, its application is broadening to optical films for liquid-crystal display devices. In liquid-crystal display devices, optical films are used as a protective film for a polarizer therein, and as a retardation film for the STN (super-twisted nematic)-type liquid-crystal display element therein as fabricated by stretching the film to thereby make it express an in-plane retardation (Re) and a thickness-direction retardation (Rth).

Recently, VA (vertical alignment)-type and OCB (optically-compensated bent)-type display devices that are required to have a higher Re and Rth retardation than STN-type devices have been developed, for which, therefore, optical film materials having an excellent retardation expressibility are desired. As a novel optical film material capable of satisfying the requirement, disclosed is a solution-cast film formed of a mixed ester of acetyl/propionyl cellulose (cellulose acetate propionate) (see JP-A-2001-188128). Cellulose acetate butyrate and cellulose acetate propionate have a lower melting point than cellulose acetate, and a method of using optical films is disclosed that are formed of such cellulose acylates through melt-casting film formation (see JP-A-2000-352620).

Except cellulose acetate, various commercial products of cellulose acylates are available, such as cellulose acetate butyrate and cellulose acetate propionate for molding materials and coating materials (see Eastman Chemical's catalogue (1994) ).

However, cellulose acetate butyrate and cellulose acetate propionate described in these patent references and non-patent reference have a low acylation reactivity and are problematic in that they may readily contain minor impurities when produced under the same reaction condition as that for cellulose acetate. Though the details of the actual conditions thereof are not clear, the minor impurities would be unreacted cellulose and cellulose having a low degree of acylation. When the film formed of such a cellulose acylate is used to construct a polarizer and when the polarizer is built in a liquid-crystal display device, then it may cause an abnormal polarization state since the refractivity of the insoluble or infusible minor impurities differs from that of the cellulose ester, and in some service condition, it may cause some defects such as light leakage to thereby lower the quality of the liquid-crystal display device. As combined with the recent tendency toward more advanced high-definition liquid-crystal display devices, the reduction in the content of minor impurities in optical films is considered as one important factor necessary for optical film materials.

For reducing minor impurities in cellulose acetate butyrate and cellulose acetate propionate, a method is disclosed that comprises filtering a dissolved solution through a filter (see JP-A-2001-188128).

The method may be effective for reducing minor impurities when the condition for filtration is suitably selected; but in case where the amount of minor impurities in cellulose ester is large, then the method may be problematic in point of the increase in the filtration pressure and of the reduction in the producibility owing to the consumption of the filter material used therein. In addition, when the method is applied to melt casting film formation, then the load of impurities to the producibility may be further larger. Accordingly, it is indispensable to basically reduce the amount of minor impurities that cellulose acylate may contain.

For reducing the amount of minor impurities, elevating the reaction temperature, or prolonging the reaction time, or increasing the catalyst amount may be effective. However, in acylation of cellulose, depolymerization may go on simultaneously with it; and therefore, when the minor impurities therein are reduced to an acceptable level in producing cellulose acetate butyrate or cellulose acetate propionate, then the mean molecular weight of the cellulose ester after the completion of acylation is often lower than that of cellulose acetate.

When applied to solution-casting film formation, the cellulose ester having a low mean molecular weight may cause some problems in that the solution viscosity lowers and the film may peel from a support during its formation; and when applied to melt-casting film formation, the cellulose acylate having a low degree of polymerization may worsen the mechanical properties of the film formed. For these reasons, it is necessary to evade as much as possible the reduction in the molecular weight of cellulose acylate in the process of producing it; but in the prior-art technique, it is difficult to satisfy both the requirement for reducing the amount of minor impurities in cellulose ester and the requirement for preventing the reduction in the mean molecular weight of cellulose ester.

### SUMMARY OF THE INVENTION

In consideration of the problems with the prior-art technique as above, an object of the present invention is to provide a method for producing a cellulose acylate which has a high mean molecular weight and contains few minor impurities and which is suitable to optical films. Another object of the invention is to provide a high-quality polarizer, retardation film, optical film and liquid-crystal display device comprising the cellulose acylate.

The present inventors have assiduously studied, and, as a result, have found that depolymerization of cellulose acylate goes on not only in the acylation step but also in the subsequent step (acylation-stopping step) of hydrolyzing excessive acid anhydride after the acylation step to a significant degree, and that the reaction speed depends on the temperature in the acylation-stopping step. Further, the present inventors have found that, when the temperature of the reaction mixture in the acylation-stopping step is controlled to fall between −50° C. and 35° C., preferably between −30° C. and 35° C., more preferably between −20° C. and 30° C., even more preferably between −10° C. and 25° C., then the depolymerization may be lowered to a level of no problem in practice, and have completed the present invention. Specifically, the invention has made it possible to produce a cellulose acylate having a high mean molecular weight and containing few minor impurities, and using the cellulose acylate has made it possible to produce a high-quality polarizer, retardation film, optical film and image display device.

The above-mentioned objects are attained by the invention that has the constitutions mentioned below.

[1] A method for producing a cellulose acylate satisfying the following formulae (1) to (3), which comprises:

1) acylating cellulose with an esterifying agent that contains an excessive amount of an acid anhydride relative to the hydroxyl group of cellulose (acylation step), and then

2) mixing the reaction mixture with a water-containing reaction stopper to thereby hydrolyze the acid anhydride while controlling the temperature of the reaction mixture to fall between −30° C. and 35° C. (acylation-stopping step):
2.0≦A+B≦3 (1),
0≦A≦2.9 (2),
0.1≦B≦3 (3),
wherein A means a substitution degree for an acetyl group, and B means a total substitution degree for acyl groups having from 3 to 9 carbon atoms.
[2] The method for producing a cellulose acylate of [1], wherein the number-average molecular weight by GPC of the cellulose acylate is from 40000 to 500000.
[3] The method for producing a cellulose acylate of [1], wherein the number-average molecular weight by GPC of the cellulose acylate is from 60000 to 300000.
[4] The method for producing a cellulose acylate of [1], wherein the number-average molecular weight by GPC of the cellulose acylate is from 85000 to 300000.
[5] The method for producing a cellulose acylate of any one of [1] to [4], wherein the temperature of the reaction mixture is controlled to fall between −20° C. and 30° C. in the acylation-stopping step.
[6] The method for producing a cellulose acylate of any one of [1] to [5], wherein the reaction stopper is mixed, taking from 3 minutes to 3 hours, in the acylation-stopping step.
[7] The method for producing a cellulose acylate of any one of [1] to [6], wherein the reaction stopper is an aqueous solution of a carboxylic acid having from 2 to 4 carbon atoms, which contains from 5% by mass to 80% by mass of water.
[8] The method for producing a cellulose acylate of any one of [1] to [7], wherein the cellulose acylate has a propionyl group or a butyryl group as the acyl group having from 3 to 9 carbon atoms.
[9] The method for producing a cellulose acylate of any one of [1] to [8], wherein the ultimate temperature in the acylation step is from 10° C. to lower than 25° C.
[10] A cellulose acylate film formed of the cellulose acylate produced according to the production method of any one of [1] to [9].
[11] The cellulose acylate film of [10], which has a residual solvent content of at most 0.01% by mass.
[12] The cellulose acylate film of [10], which is formed through solution-casting film formation.
[13] The cellulose acylate film of [10], which is formed through melt-casting film formation.
[14] The cellulose acylate film of any one of [10] to [13], wherein the in-plane retardation (Re) and the thickness-direction retardation (Rth) of the film satisfy the following formulae (4) and (5):
0 nm≦Re≦300 nm (4),
−200 nm≦Rth≦500 nm (5).
[15] A polarizer comprising a polarizing film and a protective film, wherein the protective film is a cellulose acylate film of any one of [10] to [14].
[16] A retardation film comprising a cellulose acylate film of any one of [10] to [14].
[17] An optical film having, on at least one film selected from a group consisting of a cellulose acylate film of any one of [10] to [14], a polarizer of [15] and a retardation film of [16], an optically-anisotropic layer that contains an aligned liquid-crystalline compound.
[18] An image display device comprising at least one film selected from a group consisting of a cellulose acylate film of any one of [10] to [14], a polarizer of [15], a retardation film of [16] and an optical film of [17].

According to the production method of the invention, a cellulose acylate may be produced, which has a high mean molecular weight and contains few minor impurities. The cellulose acylate may be formed into a film suitable to optical application. Accordingly, the invention may provide a high-quality polarizer, retardation film, optical film and liquid-crystal display device.

### BEST MODE FOR CARRYING OUT THE INVENTION

<Method for Producing Cellulose Acylate>

(Cellulose Acylate)

The cellulose acylate to be produced according to the production method of the invention (hereinafter this may be referred to as “the cellulose acylate of the invention”) is described in detail hereinunder.

The glucose units with β-1,4 bonding to each other to constitute cellulose have a free hydroxyl group at the 2-, 3- and 6-positions thereof. Cellulose acylate is a polymer derived from it through partial or complete esterification of those hydroxyl groups therein. The substitution degree in the cellulose acylate of the invention means the total ratio of esterification of the 2-, 3- and 6-positioned hydroxyl groups therein (the substitution degree of 1 at each position means 100% esterification at that position). When all the 2-, 3- and 6-positioned hydroxyl groups are esterified, then the substitution degree is 3. Natural cellulose material may contain any other polymer (hemicellulose) of other constitutive saccharides than glucose (e.g., xylose, mannose), and any other component than cellulose such as lignin, depending on the organic material from which it is derived and on the purification method employed for it. In the invention, all polymers produced by acylating the cellulose material containing them are within the scope of the generic term of “cellulose acylate”.

The acyl group in the cellulose acylate of the invention may be any of an aliphatic acyl group and an aromatic acyl group, but is characterized in that it includes at least an acyl group having from 3 to 9 carbon atoms. In case where the acyl group in the cellulose acylate of the invention is an aliphatic acyl group, it preferably has from 2 to 7 carbon atoms, more preferably from 2 to 5 carbon atoms, even more preferably from 2 to 4 carbon atoms. Examples of the aliphatic acyl group are an alkylcarbonyl group, an alkenylcarbonyl group, and an alkynylcarbonyl group. In case where the acyl group is an aromatic acyl group, it preferably has from 7 to 9 carbon atoms, more preferably 7 or 8 carbon atoms, even more preferably 7 carbon atoms. These acyl groups may have a substituent.

Preferred examples of the acyl group are an acetyl group, a propionyl group, a butyryl group, a heptanoyl group, a hexanoyl group, an octanoyl group, a 2-methylpropionyl group, a cyclohexanecarbonyl group, a benzoyl group, a 4-methylbenzoyl group, a 2,6-dimethylbenzoyl group, a phthaloyl group, a cinnamoyl group. Of those, more preferred are an acetyl group, a propionyl group, a butyryl group, a hexanoyl group, a benzoyl group; and even more preferred are an acetyl group, a propionyl group, a butyryl group.

The cellulose acylate of the invention may be a mixed ester, and its preferred examples are cellulose acetate propionate, cellulose acetate butyrate, cellulose propionate butyrate, cellulose acetate propionate butyrate, cellulose acetate hexanoate, cellulose acetate octanoate, cellulose acetate cyclohexanecarboxylate, cellulose acetate sulfate, cellulose propionate sulfate, cellulose acetate propionate sulfate, cellulose butyrate sulfate, cellulose acetate butyrate sulfate, cellulose acetate benzoate. More preferred examples are cellulose acetate propionate, cellulose acetate butyrate, cellulose propanoate butyrate, cellulose acetate hexanoate, cellulose acetate octanoate. Even more preferred examples are cellulose acetate propionate, cellulose acetate butyrate.

The cellulose acylate of the invention is characterized in that it has substitution degrees satisfying the following formulae (1) to (3):
2.0≦A+B≦3 (1),
0≦A≦2.9 (2),
0.1≦B≦3 (3),
wherein A means a substitution degree for an acetyl group (hereinafter this may be referred to as a degree of acetyl substitution), and B means a total substitution degree for acyl groups having from 3 to 9 carbon atoms. In this description, (A+B) indicates a total substitution degree for acyl groups.

In the invention, the total degree of acylation (A+B) is preferably from 2.3 to less than 3, more preferably from 2.5 to less than 2.98, even more preferably from 2.6 to less than 2.95.

The substitution degree for an acetyl group (A) is preferably from 0.05 to less than 2.8, more preferably from 0.1 to less than 2.5, even more preferably from 0.2 to less than 2.2.

The substitution degree for acyl groups having from 3 to 9 carbon atoms, which is represented by B, is preferably from 0.2 to less than 2.98, more preferably from 0.5 to less than 2.8, even more preferably from 0.7 to less than 2.7.

In the invention, the substitution degree distribution at the 2-, 3- and 6-positioned hydroxyl groups in cellulose is not specifically defined. In the invention, at least two different types of cellulose acylates may be mixed. In case where a cellulose acylate film having a multi-layered structure is produced, then different types of cellulose acylates may be used for the constitutive layers, or mixtures of at least two different types of cellulose acylates may be used for them.

The substitution degree for an acyl group (mean substitution degree) may be determined according to a method of ASTM D-817-91, or according to a method that comprises completely hydrolyzing the cellulose acylate to be analyzed and quantifying the resulting free carboxylic acid or its salt through gas chromatography or high-performance liquid chromatography, or according to a method of ¹H-NMR or ¹³C-NMR, optionally as combined.

When the cellulose acylate of the invention is cellulose acetate propionate, then the degree of acetyl substitution (A) is preferably from 0.2 to 1.8, more preferably from 0.25 to 1.5, even more preferably from 0.25 to 1.0. The substitution degree for a propionyl group (hereinafter this may be referred to as degree of propionyl substitution) is preferably from 0.9 to 2.7, more preferably from 1.4 to 2.65, even more preferably from 1.5 to 2.6. The total degree of acyl substitution (A+B) is preferably from 2.75 to 2.99, more preferably from 2.77 to 2.97, even more preferably from 2.80 to 2.95.

When the cellulose acylate of the invention is cellulose acetate butyrate, then the degree of acetyl substitution (A) is preferably from 0.3 to 2.0, more preferably from 0.4 to 1.8, even more preferably from 0.6 to 1.5. The substitution degree for a butyryl group (hereinafter this may be referred to as degree of butyryl substitution) is preferably from 0.5 to 2.7, more preferably from 0.8 to 2.5, even more preferably from 1.0 to 2.4. The total degree of acyl substitution (A+B) is preferably from 2.70 to 2.99, more preferably from 2.75 to 2.97, even more preferably from 2.80 to 2.95.

(Starting Material and Pretreatment)

The cellulose material to be used in the production method of the invention is preferably one derived from broad-leaved tree pulp, coniferous tree pulp, cotton linter. The cellulose material is preferably a high-purity one having an α-cellulose content of from 92% by mass to 99.9% by mass.

When the cellulose material is a sheet-like or massive one, then it is preferably previously beaten. Regarding its morphology, the cellulose material is preferably beaten into a floccular, feather-like or powdery one. The starting cellulose for the cellulose acylate and a general method for preparing it are described in Hatsumei Kyokai Disclosure Bulletin (No. 2001-1745, published on Mar. 15, 2001 by the Hatsumei Kyokai), pp. 7-12.

(Activation)

Before acylated, the cellulose material is preferably brought into contact with an activator (for activation). For the activator, preferably used is a carboxylic acid, water, or a mixture of the two. When water is used, then the activation process preferably includes a step of adding an excessive amount of an acid anhydride to the material for dehydration after the activation, or washing the material with a carboxylic acid for substitution with it for water, or controlling the condition for acylation. The activator may be controlled at any temperature before added, and the addition method may be selected from spraying, dripping addition, and dipping.

The carboxylic acid preferred for the activator may have from 2 to 9 carbon atoms, including, for example, acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, heptanoic acid, cyclohexanecarboxylic acid, benzoic acid. More preferred are acetic acid, propionic acid, butyric acid; and even more preferred is acetic acid.

In activation, an acylation catalyst such as sulfuric acid may be added to the material, if desired. However, when a strong acid such as sulfuric acid is added, then the depolymerization may be promoted. Therefore, the amount of the acid to be added is preferably up to from 0.1% by mass to 10% by mass or so. As the case may be, two or more different types of activators may be combined, or an anhydride of a carboxylic acid having from 2 to 9 carbon atoms may be added to the material.

Preferably, the amount of the activator to be added is at least 5% by mass of cellulose, more preferably at least 10% by mass, even more preferably at least 30% by mass. When the amount of the activator is at least 5% by mass, then it is desirable since there may occur no trouble of the reduction in the degree of activation of cellulose. The uppermost limit of the amount of the activator is not specifically defined so far as it does not lower the producibility. Preferably, the uppermost limit is at most 100 times by mass of cellulose, more preferably at most 20 times by mass, even more preferably at most 10 times by mass. A large excessive amount of activator may be added to cellulose for activation, and then the amount of the activator may be reduced through filtration, centrifugation, aeration drying, thermal drying, reduced pressure vaporization or solvent substitution, optionally as combined.

Preferably, the time for activation is at least 20 minutes. Its uppermost limit is not specifically defined so far as it does not have any negative influence on the producibility. Preferably, the time is at most 72 hours or less, more preferably at most 24 hours, even more preferably at most 12 hours. The activation temperature is preferably from 0° C. to 90° C., more preferably from 15° C. to 80° C., even more preferably from 20° C. to 70° C. The cellulose activation may be attained under pressure or under reduced pressure. For heating cellulose in its activation, usable are electromagnetic waves such as microwaves or IR rays.

(Acylation)

In the production method of the invention, it is desirable that a carboxylic acid anhydride is added to and reacted with cellulose in the presence of a Broensted acid or a Lewis acid serving as a catalyst to thereby acylate the hydroxyl group in the cellulose.

In case where cellulose acylate having a large degree of 6-substitution is produced, the descriptions in JP-A-11-5851, JP-A-2002-212338 and JP-A-2002-338601 may be referred to.

(Acid Anhydride)

For the carboxylic acid anhydride, the carboxylic acid preferably has from 2 to 9 carbon atoms. For example, the acid anhydride includes acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentanecarboxylic anhydride, heptanoic anhydride, cyclohexanecarboxylic anhydride, benzoic anhydride.

More preferred are acid anhydrides such as acetic anhydride, propionic anhydride, butyric anhydride, valeric anhydride, hexanoic anhydride, heptanoic anhydride; and even more preferred are acetic anhydride, propionic anhydride, butyric anhydride.

In the production method of the invention, the acid anhydride is added to cellulose in an excessive amount over the hydroxyl group in the cellulose. Specifically, the acid anhydride is added in an amount of from 1.1 to 50 equivalents relative to the hydroxyl group in cellulose, more preferably from 1.2 to 30 equivalents, even more preferably from 1.5 to 10 equivalents.

For obtaining a cellulose mixed acylate, preferred is a method of reacting two types of carboxylic acid anhydrides as the acylating agent with cellulose through simultaneous or successive addition thereof to cellulose; a method of suing a mixed acid anhydride of two carboxylic acids (e.g., mixed acid anhydride of acetic acid/propionic acid); or a method of forming a mixed acid anhydride (e.g., acetic/propionic mixed anhydride) from a carboxylic acid and an anhydride of a different carboxylic acid anhydride (e.g., acetic acid and propionic anhydride) in a reaction system, and reacting it with cellulose. Apart from these, also employable is a method of once producing a cellulose acylate having a substitution degree of less than 3 according to the production method of the invention followed by further acylating the remaining hydroxyl group with an acid anhydride or an acid halide.

When carboxylic acids or acid anhydrides that differ in point of the number of the carbon atoms constituting them are used as combined for the purpose of producing a mixed ester, it is desirable that the composition ratio of the mixture is determined in accordance with the substitution ratio in the intended mixed ester.

(Catalyst)

The acylation catalyst to be used in producing the cellulose acylate in the invention is preferably a Broensted acid or a Lewis acid. Regarding the definition of Broensted acid and Lewis acid, for example, referred to is “Physics and Chemistry Dictionary”, 5th Ed., 2000. Preferred examples of the Broensted are sulfuric acid, perchloric acid, phosphoric acid, methanesulfonic acid, benzenesulfonic acid, p-toluenesulfonic acid. Preferred examples of the Lewis acid are zinc chloride, tin chloride, antimony chloride, magnesium chloride.

The catalyst is more preferably sulfuric acid or perchloric acid, even more preferably sulfuric acid. The amount of the catalyst to be added to the reaction system is preferably from 0.1 to 30% by mass of cellulose, more preferably from 1 to 15% by mass, even more preferably from 3 to 12% by mass. The concentration of the catalyst is preferably from 0.001 to 15% by mass of the reaction mixture, more preferably from 0.01 to 10% by mass, even more preferably from 0.1 to 5% by mass.

(Solvent)

In acylation, a solvent may be added to the reaction system for the purpose of controlling the viscosity, the reaction speed, the stirring capability and the acyl substitution ratio. The solvent includes dichloromethane, chloroform, carboxylic acid, acetone, ethyl methyl ketone, toluene, dimethylsulfoxide and sulforane, and is preferably a carboxylic acid, for example, a carboxylic acid having from 2 to 9 carbon atoms {e.g., acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclohexanecarboxylic acid}. More preferred are acetic acid, propionic acid, and butyric acid. These solvent may be mixed to be a mixed solvent for use herein.

The amount of the solvent may be determined in any desired manner. Preferably, the amount is from 0 to 5000% by mass of cellulose, more preferably from 0 to 3000% by mass, even more preferably from 0 to 2000% by mass.

The total amount of the activator, the acylating agent, the solvent and the catalyst is preferably from 1.5/1 to 100/1 in terms of the ratio thereof to cellulose by mass, more preferably from 1.9/1 to 50/1, even more preferably from 3/1 to 20/1.

(Acylation Condition)

In acylation, an acid anhydride, a catalyst and optionally a solvent may be mixed first and then with cellulose; or they may be successively mixed with cellulose. In general, however, it is desirable that a mixture of an acid anhydride and a catalyst, or a mixture of an acid anhydride, a solvent and a catalyst is prepared as an acylating agent, and this is reacted with cellulose. For preventing the inner temperature of the reactor from rising owing to the reaction heat in acylation, it is desirable that the acylating agent is previously cooled. The cooling temperature is preferably from −50° C. to 20° C., more preferably from −35° C. to 10° C., even more preferably from −25° C. to 5° C. The acylating agent to be added to cellulose may be liquid, or it may be frozen and the resulting crystal, flaky or block solid may be added to cellulose.

The acylating agent may be added to cellulose all at a time, or, as divided into portions, it may be added thereto at different times. Cellulose may be added to the acylating agent all at a time, or, as divided into portions, it may be added thereto at different times. In case where the acylating agent is divided into portions and added to cellulose at different times, then an acylating agent having the same composition may be used, or plural acylating agents each having a different composition may be used. Preferred embodiments are as follows: 1) An acylating agent solution with a catalyst is first added, and then an acylating agent not containing a catalyst is added. 2) An acylating agent not containing a catalyst is first added, and then an acylating agent solution containing a catalyst is added. 3) An acylating agent containing a part of a catalyst is first added, and then an acylating agent containing the remaining catalyst is added. These combinations may be further combined with another modification where the composition ratio of the solvent and the acid anhydride in the acylating agent is varied in any desired manner.

The acylation of cellulose is exothermic reaction. However, in the method of producing the cellulose acylate of the invention, it is desirable that the ultimate temperature during the acylation is lower than 50° C. The reaction temperature is preferably lower than 50° C., which would not cause any inconvenience of promoting depolymerization to make it difficult to obtain cellulose acylate having a degree of polymerization suitable to the application of the invention. More preferably, the ultimate temperature during the acylation is lower than 35° C., even more preferably lower than 25° C., especially preferably lower than 20° C. The reaction temperature may be controlled with a temperature controller or by controlling the initial temperature of the acylating agent used. The pressure in the reactor may be reduced, whereby the reaction temperature may be controlled by the heat of evaporation of the liquid component in the reaction system. The heat generation during the acylation is great in the initial stage of the reaction, and therefore, the reactor may be cooled at the initial stage of the reaction and then it may be heated for the reaction temperature control. The end point of the acylation may be known through determination of the light transmittance, the solution viscosity and the temperature change in the reaction system, through determination of the solubility of the reaction product in an organic solvent, or through microscopic observation or polarization-microscopic observation of the reaction system. In general, a point at which the unreacted cellulose have disappeared in the reaction mixture is the end point of the acylation.

Preferably, the lowermost reaction temperature is −50° C. or higher, more preferably −30° C. or higher, even more preferably −20° C. or higher. Preferably, the acylation time is from 0.5 hours to 24 hours, more preferably from 1 hour to 12 hours, even more preferably from 1.5 hours to 6 hours. When the reaction time is 0.5 hours or more, then the reaction may well go on under any ordinary reaction condition; and when it is 24 hours or less, then the industrial production efficiency may be good.

(Reaction Stopper)

The production method of the invention is characterized in that a reaction stopper is added to the reaction system after the acylation.

The reaction stopper for use in the invention may be a water-containing composition, which may optionally contain any other substance than water capable of decomposing an acid anhydride (e.g., alcohol such as methanol, ethanol, propanol, butanol, isopropyl alcohol). The reaction stopper may contain a neutralizing agent mentioned hereinunder.

Regarding examples of the water-containing composition, any combination may be usable herein. In order to evade such an inconvenience that the cellulose acylate formed may precipitate in an undesirable morphology thereof, it is desirable to add a mixture of water with a solvent (e.g., carboxylic acid such as acetic acid, propionic acid, butyric acid; or dimethylformamide, dimethylacetamide, N-methylpyrrolidone, dimethylsulfoxide, acetonitrile, acetone) to the reaction system rather than direct addition of water alone thereto. A carboxylic acid is more preferred for the solvent; acetic acid, propionic acid and butyric acid are even more preferred; and acetic acid is still more preferred. The composition ratio of solvent to water may be determined in any desired manner. Preferably, for example, the water content of the mixture is from 5% by mass to 80% by mass, more preferably from 10% by mass to 60% by mass, even more preferably from 15% by mass to 50% by mass. One water-containing composition, or two or more different water-containing compositions may be used either singly or as combined in any desired manner.

The amount of water to be added to the reaction system may be at least an equivalent amount to the remaining acid anhydride, but is preferably an excessive amount over it. The excessive amount of water may be suitably determined depending on the substitution degree of the intended cellulose acylate, the substitution degree distribution thereof, the molecular weight thereof, and the remaining sulfate acid amount therein. For example, at the end point of the hydrolysis of the acid anhydride, the amount of water to be added to the system is preferably from 0.1 to 50 mol % of the carboxylic acid in the reaction mixture (not including the acid having bonded to cellulose as an acyl group), more preferably from 0.5 to 40 mol %, even more preferably from 1 to 30 mol %.

The invention is characterized in that, in the reaction-stopping step, a water-containing reaction stopper is mixed with the reaction mixture to hydrolyze the acid anhydride therein while the temperature of the reaction mixture is controlled to fall between −30° C. and 35° C. Preferably, the temperature of the reaction mixture in the reaction-stopping step is from −20° C. to 30° C., more preferably from −15° C. to 25° C., even more preferably from −15° C. to 23° C.

The hydrolysis of acid anhydride is exothermic reaction. However, when the temperature of the reaction mixture during the reactions-stopping step is higher than 35° C., then the depolymerization that may occur owing to the heat generation during the reaction-stopping step could not be negligible.

In general, cellulose acylate having a propionyl group or a butyryl group has a low reactivity for acylation and may have a lower mean molecular weight than cellulose acetate at the end of the acylation thereof. According to the invention, however, even the cellulose acylate of the type produced may have a high molecular weight.

The production method of the invention is applicable to production of cellulose acylate having any non-limited molecular weight, but is preferably applied to production of cellulose acylate having a number-average molecular weight by GPC (gel permeation chromatography) of from 40000 to 500000, more preferably from 60000 to 300000, even more preferably from 80000 to 300000. For the method of measuring the mean degree of polymerization of polymer, herein employable is, for example, an Uda et al's limiting viscosity method (Kazuo Uda, Hideo Saito; the Journal of the Society of Fiber Science and Technology of Japan, Vol. 18, No. 1, pp. 105-120, 1962).

Regarding its addition, the reaction stopper may be added to the acylation reactor, or the reaction product may be added to a reaction stopper-containing reactor. Preferably, the reaction stopper is added to the system, taking from 3 minutes to 3 hours. When the time to be taken for the addition of the reaction stopper is 3 minutes or more, then the inconveniences may be favorably prevented of such that the heat generation is too great and causes the reduction in the degree of polymerization of the produced polymer, that the acid anhydride is insufficiently hydrolyzed, and that the stability of the cellulose acylate produced is lowered. When the time to be taken for the addition of the reaction stopper is 3 hours or less, then any industrial problem of producibility reduction may be favorably prevented. The time to be taken for the addition of the reaction stopper is preferably from 4 minutes to 2 hours, more preferably from 5 minutes to 1.5 hours, even more preferably from 10 minutes to 1 hour. When the reaction stopper is added thereto, the reactor may be cooled or may not be cooled. For the purpose of keeping the temperature of the reaction mixture falling within the scope of the invention, it is desirable that the reactor is cooled to prevent the temperature elevation therein. Also preferably, the reaction stopper may be previously cooled.

(Neutralizing Agent)

During or after the acylation-stopping step, a neutralizing agent or its solution may be added to the system for the purpose of hydrolyzing the excessive carboxylic acid anhydride still remaining in the system, or for neutralizing a part or all of the carboxylic acid and the esterification catalyst therein, or for controlling the residual sulfate radical amount and the residual metal amount therein.

Preferred examples of the neutralizing agent are carbonates, hydrogencarbonates, organic acid salts (e.g., acetates, propionates, butyrates, benzoates, phthalates, hydrogenphthalates, citrates, tartrates), hydroxides or oxides of ammonium, organic quaternary ammoniums (e.g., tetramethylammonium, tetraethylammonium, tetrabutylammonium, diisopropyldiethylammonium), alkali metals (preferably lithium, sodium, potassium, rubidium, cerium; more preferably lithium, sodium, potassium; even more preferably sodium, potassium), Group 2 metals (preferably beryllium, calcium, magnesium, strontium, barium; more preferably calcium, magnesium barium; even more preferably calcium, magnesium), Group 3 to 12 metals (e.g., iron, chromium, nickel, copper, lead, zinc, molybdenum, niobium, titanium), or Group 13 to 15 elements (e.g., aluminium, tin, antimony). These neutralizing agents may be mixed into a mixed salt (e.g., magnesium acetate propionate, potassium sodium tartrate) for use herein.

More preferably, the neutralizing agent is alkali metal or Group 2 metal carbonates, hydrogencarbonates, organic acid salts, hydroxides or oxides; even more preferably sodium, potassium or calcium carbonates, hydrogencarbonates, acetates or hydroxides.

Preferred example of the solvent for the neutralizing agent are water, alcohols (e.g., ethanol, methanol, propanol, isopropyl alcohol), organic acids (e.g., acetic acid, propionic acid, butyric acid), ketones (e.g., acetone, ethyl methyl ketone), and other polar solvents such as dimethylsulfoxide, dimethylformamide, dimethylacetamide, and their mixed solvents.

(Partial Hydrolysis)

The cellulose acylate thus obtained in the manner as above may have a total degree of acyl substitution of nearly 3, but in general, for the purpose of obtaining a polymer having a desired substitution degree, the polymer produced may be partially hydrolyzed at the ester bond therein by keeping it in the presence of a small amount of a catalyst (generally, an acylation catalyst such as the remaining sulfuric acid) and water, at 20 to 90° C. for a few minutes to a few days, whereby the degree of acyl substitution of the cellulose acylate is reduced to a desired level (this is referred to as ripening). During the step of partial hydrolysis, the sulfate of cellulose may also be hydrolyzed. Accordingly, by controlling the hydrolysis condition, the amount of the sulfate bonding to cellulose may be reduced.

A method of controlling the substitution degree of cellulose acetate and the substitution degree distribution thereof through control of partial hydrolysis condition is described in JP-A-2003-201301.

(Stopping of Partial Hydrolysis)

At the time when cellulose acylate having a desired substitution degree has been obtained as a result of the promotion of partial hydrolysis, it is desirable that the catalyst still remaining in the system is completely neutralized with the above-mentioned neutralizing agent or its solution to thereby stop the partial hydrolysis. The amount of the neutralizing agent to be added to the reaction mixture is preferably an excessive amount over the sulfate radical (free sulfuric acid, sulfuric acid bonding to cellulose) in the mixture. The neutralizing agent may be added all at a time or may be divided into portions and added separately. It is desirable that, after the completion of partial hydrolysis (ripening), the neutralizing agent is added to the mixture in such a manner that its amount could be an excessive equivalent amount over the sulfate radical in the mixture.

Sulfuric acid bonding to cellulose (cellulose sulfate) is a monovalent acid, but in the invention, its amount is converted into an amount corresponding to the amount of a free acid thereof in calculating the equivalent amount of the neutralizing agent to be used. Accordingly, the equivalent amount of the neutralizing agent may be obtained from the amount of sulfuric acid added to the system. In the invention, the amount of the neutralizing agent to be added is preferably from 1.2 to 50 equivalents to the sulfate radical, more preferably from 1.3 to 20 equivalents, even more preferably from 1.5 to 10 equivalents.

A neutralizing agent capable of producing a salt of low solubility in the reaction solution (e.g., magnesium carbonate, magnesium acetate) may be preferably added to the system, whereby the catalyst (e.g., sulfates) existing in the solution or bonding to cellulose may be effectively removed.

(Post-Heating Step)

In the production method of the invention, it is also desirable that the reaction mixture after the termination of the above partial hydrolysis is kept at 30° C. to 100° C. (post-heating step). Through the step, the amount of sulfate bonding to the cellulose acylate may be further reduced, and the cellulose acylate produced may have a better heat stability. Not restrained by any theory, the reason why the bonding sulfate amount to cellulose acylate is lowered through the step would be because, since the cellulose acylate solution is heated in the presence of an excessive base, the sulfate that may be more readily hydrolyzed than the acyl ester could be gradually de-esterified and the resulting free sulfuric acid could be neutralized with the base whereby the equilibrium would be shifted to the side of de-esterification.

In the post-heating step, the temperature at which the system is kept is preferably from 30° C. to 100° C., more preferably from 50° C. to 90° C., even more preferably from 60° C. to 80° C. When the temperature is 30° C. or higher, then the effect of reducing the bonding sulfate amount may be sufficient; and when it is 100° C. or lower, then it is advantageous in point of the operation and the safety. The time for the post-heating step is preferably from 15 minutes to 100 hours, more preferably from 30 minutes to 100 hours, even more preferably from 1 hour to 50 hours. When the time is 15 minutes or more, then the effect of reducing the bonding sulfate amount may be sufficient; and when it is 100 hours or less, then it is advantageous in point of the industrial producibility. In the post-heating step, the reaction mixture is preferably stirred. Neutralizing agent, water, solvent or their mixture may be additionally given to the system in the post-heating step.

(Filtration)

For the purpose of removing or reducing the unreacted substance, the hardly-soluble salt and other impurities in the cellulose acylate produced herein, the reaction mixture (dope) may be filtered. The filtration may be attained in any step after the acylation but before reprecipitation, but is preferably effected just before reprecipitation.

The retention particle size of the filter to be used for the filtration is preferably from 0.1 μm to 50 μm, more preferably from 0.5 μm to 40 μm, even more preferably from 1 μm to 30 μm. When the retention particle size of the filter is 0.1 μm or more, then the filtration pressure would not rise excessively and would be suitable for practical industrial production. When the retention particle size is 40 μm or less, then the removal of impurities would be more sufficient. The filtration may be repeated twice or more.

Not specifically defined, the material of the filter may be any one not negatively influenced by the solvent used. Its preferred examples are cellulose filters, metal filters, sintered metal filters, sintered ceramic filters, Teflon filters (PTFE filters), polyether sulfone filters, polypropylene filters, polyethylene filters, glass fiber filters. These may be combined for use herein. Of those, preferred are stainless metal filters and sintered metal filters.

As the filter material, a filter having a charge-trapping function may also be preferably used. The filter having a charge-trapping function is a filter having a function of electrically trapping and removing charged impurities, for which, in general, an electrically-charged filter material may be used. Examples of the filter of the type are described in JP-T-4-504379, JP-A-2000-212226, and any of which may be selected for use herein.

A filtration aid such as Celite or a layered clay mineral (preferably talc, mica, kaolinite) may be mixed with a cellulose acylate solution, and this may be filtered in a mode of cake filtration. This filtration mode is preferred in the invention.

For the purpose of controlling the filtration pressure and the filtration operation, it is also desirable to previously dilute the reaction mixture with a suitable solvent.

(Reprecipitation)

The cellulose acylate solution thus obtained in the manner as above may be mixed with a bad solvent such as water or an aqueous carboxylic acid solution (e.g., acetic acid, propionic acid), or such a bad solvent may be added to the cellulose acylate solution, whereby the cellulose acylate is reprecipitated therein, and then washed and stabilized to obtain the intended cellulose acylate. The reprecipitation may be attained continuously, or may be attained batchwise every time for a predetermined amount of the solution. The concentration of the cellulose acylate solution and the composition of the bad solvent may be controlled depending on the substitution mode and the polymerization degree of the cellulose acylate and, whereby the morphology, the apparent density and the molecular weight distribution of the reprecipitated cellulose acylate may be controlled. This is also a preferred embodiment of the invention.

(Washing)

The produced cellulose acylate is preferably washed. The washing solvent may be any one in which the solubility of cellulose acylate is low and which can remove impurities. In general, it is water or hot water. The temperature of the washing water is preferably from 15° C. to 100° C., more preferably from 25° C. to 90° C., even more preferably from 30° C. to 80° C. The washing treatment may be effected in a batchwise mode of alternate filtration and washing liquid exchange, or in a continuous washing device. The waste from the step of reprecipitation and washing may be recycled as the bad solvent in the reprecipitation step, or the solvent such as carboxylic acid may be recovered from the waste through distillation and may be recycled. This is also a preferred embodiment of the invention.

The promotion of washing may be detected in any method. Preferred examples for it are methods of hydrogen ion concentration determination, ion chromatography, electric conductivity determination, ICP, elementary analysis, or atomic absorption spectrometry.

Through the treatment as above, the catalyst (e.g., sulfuric acid, perchloric acid, trifluoroacetic acid, p-toluenesulfonic acid, methanesulfonic acid, zinc chloride), the neutralizing agent (e.g., calcium, magnesium, iron, aluminium or zinc carbonate, acetate, hydroxide or oxide), the reaction product of the neutralizing agent and the catalyst, the carboxylic acid (e.g., acetic acid, propionic acid, butyric acid), and the reaction product of the neutralizing agent and the carboxylic acid in the cellulose acylate may be removed, and this is effective for increasing the stability of the produced cellulose acylate.

(Stabilization)

After washed, the cellulose acylate may be also preferably processed with a stabilizer such as an aqueous solution of a weak alkali (e.g., sodium, potassium, calcium, magnesium or aluminium carbonate, hydrogencarbonate, hydroxide, oxide), for further increasing the stability and reducing the carboxylic acid odor of the polymer. The remaining amount and the type of the stabilizer may be controlled or selected, depending on the amount of the washing liquid, the temperature and time for washing, the stirring method, the shape of the washing container, and the composition and the concentration of the stabilizer.

(Drying)

In the invention, for controlling the water content of the produced cellulose acylate to fall within a desired range, the cellulose acylate is preferably dried. Not specifically defined, the drying method may be any one capable of attaining the intended water content of the polymer. For example, heating, aeration, pressure reduction or stirring may be preferably employed either singly or as combined for effectively drying the polymer. The drying temperature is preferably from 0 to 200° C., more preferably from 40 to 150° C., even more preferably from 50 to 100° C. Preferably, the water content of the cellulose acylate of the invention is at most 2% by mass, more preferably at most 1% by mass, even more preferably at most 0.7% by mass.

(Morphology)

The cellulose acylate produced according to the production method of the invention may be in any form of various granular, powder, fibrous or massive forms. As a material for film production, the polymer is preferably a granular or powdery one. Therefore, the dried cellulose acylate may be ground or sieved for the purpose of unifying the particle size and improving the handlability thereof. When the cellulose acylate is granular, then it is desirable that at least 90% by mass of the polymer granules for use herein have a particle size of from 0.5 to 5 mm. It is also desirable that at least 50% by mass of the polymer granules for use herein have a particle size of from 1 to 4 mm. Preferably, the cellulose acylate particles are spherical as much as possible. Preferably, the cellulose acylate of the invention has an apparent density of from 0.5 to 1.3 g/cm³, more preferably from 0.7 to 1.2 g/cm³, even more preferably from 0.8 to 1.15 g/cm³. A method for measuring the apparent density is defined in JIS K-7365.

Preferably, the cellulose acylate of the invention has an angle of repose of from 10 to 70 degrees, more preferably from 15 to 60 degrees, even more preferably from 20 to 50 degrees.

(Minor Impurities)

The cellulose acylate may contain minor impurities that are difficult to detect with the naked eye but could be detected with a microscope or a polarization microscope. The minor impurities have a diameter of from 1 μm to less than 10 μm, and could be detected with a polarization microscope under a cross-Nicol condition. When a polarizer protective film is formed of a cellulose acylate that contains minor impurities and when it is built in an image display device, then there may occur some trouble caused by light leakage especially at the time of black level of display where all light is shut off. Accordingly, the acceptable level of minor impurities that may be in a cellulose acylate for optical films is preferably from 0/mm² to 10/mm², more preferably from 0/mm² to 8/mm², even more preferably from 0/mm² to 5/mm².

The minor impurities may be removed in some degree in the process of film formation by filtering the cellulose acylate solution (dope) or the molten fluid in the process, but it is desirable to remove a major part of the minor impurities in the process of producing the cellulose acylate for the purpose of preventing the filtration pressure from rising too much or preventing the frequency of filter exchange from increasing too much.

In the method of producing the cellulose acylate of the invention, the amount of the minor impurities in the polymer produced may be reduced and the degree of polymerization of the polymer may be kept high.

(Residual Solvent Amount)

The residual solvent amount in the cellulose acylate film produced according to the production method of the invention is preferably as small as possible. Concretely, the residual solvent amount is preferably at most 0.01% by mass, more preferably at most 0.005% by mass, even more preferably at most 0.001% by mass, still more preferably no residual solvent is detected. When the cellulose acylate film is produced according to the melt-casting film formation method described below, then the film produced may have a residual solvent content of at most 0.01% by mass. The residual solvent content of the film may be determined through gas chromatography.

(Residual Sulfate Radical Amount)

The residual sulfate radical amount S(S means the sulfur atom content of residual sulfate radical) in the cellulose acylate produced according to the production method of the invention is preferably 0 ppm<S<200 ppm. The residual sulfate radical amount S is more preferably 1 ppm<S<150 ppm, even more preferably 2 ppm<S<100 ppm, still more preferably 5 ppm<S<50 ppm, further more preferably 5 ppm<S<30 ppm. Within the range, the heat stability of the cellulose acylate is good. When the residual sulfate radical amount is less than 200 ppm, then there may hardly occur a problem of the reduction in the heat stability of the polymer in relation to the metal amount in the polymer mentioned hereinunder, and even when an optical film of the polymer is left at high temperatures, there may hardly occur unsuitable coloration of the film. However, when the radical amount is more than 200 ppm, then the polymer could not be put into practical and commercial use for optical films.

Though its details are not clear, the reason why the heat stability of the cellulose acylate, of which the residual sulfate radical content S falls within a range of 0 ppm<S<200 ppm, is good may be because, when a cellulose acylate having an excessive residual sulfate radical content over the range is heated as such, then the cellulose acylate may be oxidized or decomposed and may be thereby colored, and the degree of coloration increases with the increase in the residual sulfate radical content, and for these reasons, the acceptable level of the residual sulfate radical content of the polymer for use in film formation would fall within the above-mentioned range.

The residual sulfate radical amount as referred to herein is meant to indicate the total amount of all sulfate radicals that exist in cellulose acylate in the form of bound sulfuric acid, non-bound sulfuric acid, salt, ester or complex. The sulfate radical of cellulose acylate may result from the acylation catalyst, sulfuric acid, which has bonded to the hydroxyl group of cellulose to form a sulfate ester or has been taken in cellulose acylate as free sulfuric acid, salt, ester or complex, and which could not be removed in the washing step but has still remained in the polymer.

In the invention, the amount of the residual sulfate radical is defined in terms of the sulfur atom content of the radical. Specifically, for example, 98.07 g of sulfuric acid is converted into 32.06 g of sulfur atom, and the radical content is represented by the sulfur atom content. The sulfur content of cellulose acylate may be determined, for example, as follows: A sample to be analyzed is burnt in an oxygen atmosphere in a high-frequency combustion device or an electric furnace, the resulting sulfur oxide component such as sulfur dioxide is absorbed by an absorbent liquid that contains hydrogen peroxide, and the sulfur content of the sample is determined through volume titration or charge titration with the adsorbent in an aqueous sodium hydroxide solution.

(Residual Metal Amount)

In the invention, the total M of the residual alkali metal amount M1 and residual Group 2 metal amount M2 in the cellulose acylate is preferably 0 ppm<M<600 ppm, more preferably from 5 ppm<M<400 ppm, even more preferably 10 ppm<M<200 ppm. The alkali metal includes lithium, sodium, potassium rubidium, cesium, and is preferably lithium, sodium potassium, more preferably sodium, potassium. The group 2 metal includes beryllium, magnesium, calcium, strontium, barium, and is preferably magnesium, calcium, barium, more preferably magnesium, calcium. The residual metal in the cellulose acylate further improves the heat stability of the polymer. The amount and the type of the residual metal in the polymer may be controlled or selected, depending on the amount and the type of the compound added to the reaction system as a neutralizing agent and a stabilizer, the metal content of water used, and the treatment in the process of producing the polymer.

The metal amount in the cellulose acylate may be determined by analyzing a sample of the polymer, which is prepared by firing the polymer to give a residue or by pretreating the polymer for high-frequency wet ashing in nitric acid, in a mode of ion chromatography, atomic absorption spectrometry, ICP analysis or ICP-MS analysis.

Preferably, the metal/sulfur equivalent ratio in the cellulose acylate given by the following formula (A), in which S′ indicates the residual sulfate radical amount in the polymer (in terms of the molar amount of the sulfur atom content of the residual sulfate radical), M1′indicates the residual alkali metal amount by mol, and M2′ indicates the residual Group 2 element amount by mol, is preferably from 0.25 to 3, more preferably from 0.5 to 2.5, even more preferably from 0.6 to 1.8. When the metal/sulfur equivalent ratio is from 0.25 to 3, then the heat stability of the cellulose acylate is good, and there may hardly occur problems of whitening of the cellulose acylate film and the cellulose acylate solution, reduction in the weather resistance of the film, reduction in the film formability of the polymer solution, and coloration of the film.

(A): Metal/Sulfur Equivalent Ratio={(M1′/2)+M2′}/S′.

<Cellulose Acylate Film>

The cellulose acylate film of the invention is described. The cellulose acylate film of the invention is produced by forming the above-mentioned cellulose acylate film of the invention into a film. Not specifically defined, the method of film formation is preferably a melt-casting film formation method or a solution-casting film formation method.

(Melt-Casting Film Formation Method)

Preferred embodiments of the melt-casting film formation method for producing the cellulose acylate film of the invention are described below.

In the invention, one or more different types of cellulose acylate may be used for forming the polymer film. If desired, the cellulose acylate of the invention may be combined with any other polymer component in any desired manner for film formation. Preferably, the additional polymer component to be combined has good compatibility with the cellulose acylate of the invention; and also preferably, the light transmittance of the polymer film is at least 80%, more preferably at least 90%, even more preferably at least 92%.

[1] Plasticizer:

In the invention, a plasticizer may be preferably added to the film. Examples of the plasticizer are alkylphthalylalkyl glycolates, phosphates and carboxylates.

The alkylphthalylalkyl glycolates include, for example, methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate, octylphthalylethyl glycolate.

The phosphates include, for example, triphenyl phosphate, tricresyl phosphate, biphenyldiphenyl phosphate.

The carboxylates include, for example, phthalates such as dimethyl phthalate, diethyl phthalate, dibutyl phthalate, dioctyl phthalate and di(ethylhexyl) phthalate; and citrates such as acetyltrimethyl citrate, acetyltriethyl citrate, acetyltributyl citrate. In addition, butyl oleate, methylacetyl linolate, dibutyl sebacate and triacetin may also be used either singly or as combined with the above.

The amount of the plasticizer to be added is preferably from 0% by mass to 15% by mass of cellulose triacetate, more preferably from 0% by mass to 10% by mass, even more preferably from 0% by mass to 8% by mass. If desired, two or more such plasticizers may be used as combined.

[2] Stabilizer:

In the invention, at least one stabilizer may be added to the film-constitutive material before or during the step of thermally melting the cellulose acylate. The stabilizer is useful for preventing the formation of volatile components through deterioration such as typically coloration or molecular weight reduction or through decomposition of the film-constitutive material including decomposition reactions that are not as yet clarified, for example, for preventing oxidation of the material, for trapping the acid formed through decomposition, for retarding or inhibiting radical-caused decomposition by light or heat. The stabilizer itself is required to exhibit its function without being decomposed even at the melting temperature in film formation. The stabilizer is used for the following effects, which, however, are not limitative.

Typical materials of the stabilizer are phenolic stabilizers, phosphite-based stabilizers (phosphite compounds), thioether-based stabilizers, amine-based stabilizers, epoxy-based stabilizers, lactone-based stabilizers, metal inactivators (tin-based stabilizers). These are described, for example, in JP-A-3-199201, JP-A-5-190707, JP-A-5-194789, JP-A-5-271471, JP-A-6-107854.

One or more these stabilizers may be used herein either singly or as combined. The amount of the stabilizer to be added to the film-forming material may be suitably selected within a range not detracting from the object of the invention. Preferably, the amount of the stabilizer is from 0.001% by mass to 5% by mass of the cellulose, more preferably from 0.005% by mass to 3% by mass, even more preferably from 0.01% by mass to 0.8% by mass.

[2-1] Phenolic Stabilizer:

In the invention, a hindered phenolic stabilizer may be used as a compound for stabilizing the film-constitutive material in thermally melting it, and it may be any known compound, including, for example, 2,6-dialkylphenol derivatives such as typically those described in UPS 4,839,405, columns 12 to 14.

In particular, a phenolic stabilizer having a molecular weight of at least 500 is preferred for use herein. The phenolic stabilizer is preferably a hindered phenolic stabilizer.

These materials are readily available as commercial products, which are sold by various manufacturers mentioned below. For example, herein usable are Ciba Speciality Chemicals' Irganox 1076, Irganox 1010, Irganox 3113, Irganox 245, Irganox 1135, Irganox 1330, Irganox 259, Irganox 565, Irganox 1035, Irganox 1098, Irganox 1425WL; Asahi Denka Kogyo's Adekastab AO-50, Adekastab AO-60, Adekastab AO-20, Adekastab AO-70, Adekastab AO-80; Sumitomo Chemical's Sumilizer BP-76, Sumilizer BP-101, Sumilizer GA-80; and Shipro's Seenox 326A, Seenox 336B.

[2-2] Phosphite-Based Stabilizer:

For the phosphite-based stabilizer, preferred are the compounds described in JP-A-2004-182979, [0023] to [0039]. As concrete examples of the phosphite-based stabilizer, mentioned are the compounds described in JP-A-51-70326, JP-A-10-306175, JP-A-57-78431, JP-A-54-157159, JP-A-55-13765. In addition, the materials described in Hatsumei Kyokai Disclosure Bulletin (No. 2001-1745, published on Mar. 15, 2001 by the Hatsumei Kyokai), pp. 17-22 are also preferably used as the stabilizer.

The phosphite-based stabilizer for use in the invention preferably has a high molecular weight in order that it may keep its stability at high temperatures. For example, it preferably has a molecular weight of at least 500, more preferably at least 550, even more preferably at least 600. Also preferably, at least one substituent in the stabilizer is an aromatic ester. In addition, the phosphite-based stabilizer is preferably a triester, not containing impurities of phosphoric acid, monoesters and diesters. In case where the stabilizer contains such impurities, then the content of the impurities therein is preferably at most 5% by mass, more preferably at most 3% by mass, even more preferably at most 2% by mass. As concrete examples of the phosphite-based stabilizer, mentioned are the compounds described in JP-A-2004-182979, [0023] to [0039]. Further mentioned are the compounds described in JP-A-51-70316, JP-A-10-306175, JP-A-57-78431, JP-A-54-157159, JP-A-55-13765. Preferred examples of the phosphite-based stabilizer for use herein are Asahi Denka Kogyo's commercial products, Adekastab 1178, 2112, PEP-8, PEP-24G, PEP-36G, HP-10; and Clariant's commercial product, Sandostab P-EPQ. However, the phosphite-based stabilizer for use in the invention should not be limited to these. A stabilizer having both a phenolic group and a phosphite group in one molecule is also preferably used herein. Its concrete compounds are described in JP-A-10-273494, to which, however, the stabilizer for use in the invention should not be limited. One typical commercial product of the type is Sumitomo Chemical's Sumilizer GP.

[2-3] Thioether-Based Stabilizer:

The thio-based stabilizer for use herein is described. The thioether-based stabilizer that may be added to cellulose acylate in the invention preferably has a molecular weight of at least 500, and any known thioether-based stabilizer may be used herein.

Sumitomo Chemical's commercial products, Sumilizer TPL, TPM, TPS, TDP, and Asahi Denka Kogyo's Adekastab AO-412S are available.

[2-4] Epoxy-Based Stabilizer:

The epoxy-based stabilizer acts as an acid scavenger, and preferably contains the epoxy compound described in U.S. Pat. No. 4,137,201 and serving as an acid scavenger. The epoxy compound serving as an acid scavenger is known in this technical field, and it includes various polyglycol diglycidyl ethers, especially diglycidyl ethers of polyglycols or glycerols derived from condensation of 1 mol of polyglycol with from about 8 to 40 mols of ethylene oxide; metal epoxy compounds (for example, those heretofore used in vinyl chloride polymer compositions and along with vinyl chloride polymer compositions); epoxydated ether condensation products; bisphenol A diglycidyl ether (i.e., 4,4′-dihydroxydiphenyldimethylmethane), epoxydated unsaturated fatty acid esters (especially esters of fatty acids having from 2 to 22 carbon atoms with an alkyl having from 2 to 4 carbon atoms (e.g., butyl epoxystearate)); and epoxidated vegetable oil and other unsaturated natural oils such as typically compositions of various epoxydated long-chain fatty acid triglycerides (e.g., epoxydated vegetable oil) (these may be referred to as epoxydated natural glycerides or unsaturated fatty acids, in which the fatty acids generally have from 12 to 22 carbon atoms). More preferred are a commercially-available, epoxy group-containing epoxide resin compound, EPON 815C, and an epoxydated ether oligomer condensation product.

A compound having an aliphatic, aromatic, alicyclic, aromatic-aliphatic or heterocyclic structure and having an epoxy group in the side branches thereof is also useful as the epoxy-based stabilizer in the invention. The epoxy group preferably bonds to the molecular residue through ether or ester bonding thereto as a glycidyl group, or it may be an N-glycidyl derivative of a heterocyclic amine, amide or imide. Epoxy compounds of the type are well known in the art, and are readily available as commercial products. These materials are described in detail in JP-A-11-189706, [0096] to [0112].

Of the above, more preferred are epoxydated octyl linolate, epoxydated octyl ricinoleate, epoxydated soybean oil fatty acid octyl ester, epoxydated soybean oil, epoxydated linseed oil; even more preferred are epoxydated soybean oil, epoxydated linseed oil. These epoxy-based materials are available as commercial products of Adekastab O-130P and Adekastab O-180A (by Asahi Denka Kogyo).

[2-5] Tin-Based Stabilizer:

The tin-based stabilizer for use herein may be any known one. Its preferred examples are octyltin maleate polymer, monostearyltin tris(isooctyl thioglycolate), dibutyltin dilaurate.

[2-6] Acid Scavenger:

The decomposition of cellulose acylate by acid is promoted at high temperatures, and therefore the cellulose acylate film of the invention preferably contains an acid scavenger.

Not specifically defined, the acid scavenger useful in the invention may be any compound capable of reacting with acid to inactivate the acid. In particular, the epoxy group-having compounds described in U.S. Pat. No. 4,137,201 are preferred. Such epoxy compounds serving as an acid scavenger are known in this technical field. They include various polyglycol diglycidyl ethers, especially diglycidyl ethers of polyglycols or glycerols derived from condensation of 1 mol of polyglycol with from about 8 to 40 mols of ethylene oxide; metal epoxy compounds (for example, those heretofore used in vinyl chloride polymer compositions and along with vinyl chloride polymer compositions); epoxydated ether condensation products; bisphenol A diglycidyl ether (i.e., 4,4′-dihydroxydiphenyldimethylmethane); epoxydated unsaturated fatty acid esters (especially esters of fatty acids having from 2 to 22 carbon atoms with an alkyl having from 2 to 4 carbon atoms (e.g., butyl epoxystearate)); and epoxidated vegetable oil and other unsaturated natural oils such as typically compositions of various epoxydated long-chain fatty acid triglycerides (e.g., epoxydated vegetable oil) (these may be referred to as epoxydated natural glycerides or unsaturated fatty acids, in which the fatty acids generally have from 12 to 22 carbon atoms). Also preferred is a commercially-available, epoxy group-containing epoxide resin compound, EPON 815C.

Apart from the above, also usable as the acid scavenger herein are oxetane compounds, oxazoline compounds, as well as organic acid salts or acetylacetonate complexes with alkaline earth metals, and those described in JP-A-5-194788, [0068] to [0105].

The acid scavenger may be referred to also as an acid remover, an acid trapper or an acid catcher. Not limited by such naming difference, any and every substance serving as an acid scavenger is usable in the invention.

At least one of the above compounds may be selected for the acid scavenger to be in the film-forming material in the invention. The amount of the acid scavenger to be in the material is preferably from 0.001% by mass to 5% by mass of the cellulose acylate in the material, more preferably from 0.005% by mass to 3% by mass, even more preferably from 0.01% by mass to 2% by mass.

[2-7] UV Absorbent:

Preferably, one or more UV absorbents are added to the cellulose acylate of the invention. It is desirable that the UV absorbent well absorbs UV rays having a wavelength of at most 380 nm from the viewpoint of its ability to prevent the deterioration of liquid crystal, and hardly absorbs visible light having a wavelength of at least 400 nm from the viewpoint of the its liquid-crystal displaying ability. For example, the UV absorbent includes oxybenzophenone compounds, benzotriazole compounds, salicylate compounds, benzophenone compounds, cyanoacrylate compounds, nickel complex compounds. Especially preferred are benzotriazole compounds and benzophenone compounds. Above all, benzotriazole compounds are preferred as hardly causing any unnecessary coloration of cellulose acylate. These are described in JP-A-60-235852, JP-A-3-199201, JP-A-5-1907075, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239506, JP-A-2000-204173. Preferably, the amount of the UV absorbent to be added to the film-forming material in the invention is from 0.01 to 2% by mass of the melt for film formation, more preferably from 0.01 to 1.5% by mass.

A polymer UV absorbent is also usable in the invention, for which, for example, polymer UV absorbents and UV absorbent monomer-containing polymers described in JP-A-6-148430 may be used herein with no specific limitation thereon. Preferably, the polymer derived from a UV absorbent monomer for use herein has a weight-average molecular weight of from 2000 to 30000, more preferably from 5000 to 20000.

Preferably, the UV absorbent monomer content of the polymer derived from a UV absorbent monomer is from 1 to 70% by mass, more preferably from 5 to 60% by mass.

UV absorbent monomers capable of being used herein are commercially available, including, for example, 1-(2-benzotriazole)-2-hydroxy-5-(2-vinyloxycarbonylethyl)benzene, Otsuka Chemical's reactive UV absorbent RUVA-93, 1-(2-benzotriazole)-2-hydroxy-5-(2-methacryloyloxyethyl)benzene, and their analogous compounds. Polymers and copolymers prepared through homopolymerization or copolymerization of such monomers are also preferably used herein, to which, however, the invention is not limited. For example, a commercially-available polymer UV absorbent, Otsuka Chemical's PUVA-30M is also preferably used herein. Two or more UV absorbents may be used herein, as combined.

Commercially-available UV absorbents such as those mentioned below are usable herein. They include benzotriazole UV absorbents such as TINUVIN P (by Ciba Speciality Chemicals), TINUVIN 234 (by Ciba Speciality Chemicals), TINUVIN 320 (by Ciba Speciality Chemicals), TINUVIN 326 (by Ciba Speciality Chemicals), TINUVIN 327 (by Ciba Speciality Chemicals), TINUVIN 328 (by Ciba Speciality Chemicals), Sumisorb 340 (by Sumitomo Chemical), Adekastab LA-31 (by Asahi Denka Kogyo); benzophenone UV absorbents such as Seesorb 100 (by Shipro Chemical), Seesorb 101 (by Shipro Chemical), Seesorb 101S (by Shipro Chemical), Seesorb 102 (by Shipro Chemical), Seesorb 103 (by Shipro Chemical), Adekastab LA-51 (by Asahi Denka Kogyo), Chemisorp 111 (by Chemipro Chemical), UVINUL D-49 (by BASF). Also usable herein are oxalic acid anilide UV absorbents such as TINUVIN 312 (by Ciba Speciality Chemicals), and TINUVIN 315 (by Ciba Speciality Chemicals). Also usable are commercially-available salicylate UV absorbents such as Seesorb 201 (by Shipro) and Seesorb 202 (by Shipro); and cyanoacrylate UV absorbents such as Seesorb 501 (by Shipro) and UVINUL N-539 (by BASF). Of those, especially preferred is Adekastab LA-31.

The amount of the UV absorbent or the UV absorbent polymer to be used in the invention may vary, depending on the type of the compound and on the condition under which it is used. For example, the amount of the UV absorbent may be preferably from 0.2 to 3.0 g per m2 of optical film, more preferably from 0.4 to 2.0 g, even more preferably from 0.5 to 1.5 g. The amount of the UV absorbent polymer may be preferably from 0.6 to 9.0 g per m2 of optical film, more preferably from 1.2 to 6.0 g, even more preferably from 1.5 to 3.0 g.

[2-8] Hindered Amine-Based Light Stabilizer:

The light stabilizer usable herein is a hindered amine-based light stabilizer (HALS) compound, which is a known compound. For example, as in U.S. Pat. No. 4,619,956, columns 5-11, and U.S. Pat. No. 4,839,405, columns 3-5, it includes 2,2,6,6-tetraalkylpiperidine compounds, and their acid addition salts and complexes with metal compounds. These are commercially available as Adekastab LA-57, LA-52, LA-67, LA-62, LA-77 by Asahi Denka; and as TINUVIN 765, 144 by Ciba Speciality Chemicals.

One or more such hindered amine-based light stabilizer may be used herein either singly or as combined. The hindered amine-based light stabilizer may be combined with any other additive such as of plasticizer, acid scavenger, UV absorbent, or may be introduced as a part of the molecular structure of the additives. The amount of the light stabilizer to be used in the invention may be selected from a suitable range not detracting from the object of the invention. For example, the amount may be preferably from 0.01 to 20 parts by mass relative to 100 parts by mass of the polymer of the invention, more preferably from 0.02 to 15 parts by mass, even more preferably from 0.05 to 10 parts by mass. The time when the stabilizer is added may be in any stage of the process of producing a film-forming melt, or the additive may be added to the melt in the final stage of melt production.

[3] Other Additives:

In addition to the above-mentioned additives, other various additives (e.g., optical anisotropy controller, fine particles, IR absorbent, surfactant, odor trapper, (e.g., amine), light stabilizer) may be added to the polymer of the invention. IR absorbent dyes as in JP-A-2001-194522 are usable herein; and UV absorbents as in JP-A-2001-151901 are usable herein. Preferably, the amount of the absorbent to be added to cellulose acylate is from 0.001 to 5% by mass of the polymer. Preferably, the fine particles for use herein have a mean particle size of from 5 to 3000 nm, and they may be formed of a metal oxide or a crosslinked polymer. Their amount to be in cellulose acylate is preferably from 0.001 to 5% by mass of the polymer. The amount of the antioxidant is preferably from 0.0001 to 2% by mass of cellulose acylate. For the optical anisotropy controller, for example, herein usable are those described in JP-A-2003-66230 and JP-A-2002-49128. Preferably, the amount of the optical anisotropy controller is from 0.1 to 15% by mass of cellulose acylate.

(Pelletization)

When the cellulose acylate is formed into films in a mode of melt-casting film formation, it is desirable that it is optionally mixed with additives added thereto, and then pelletized and formed into films.

In pelletization, it is desirable that the additives to be added to cellulose acylate are previously dried, but when a vent-type extruder is used, drying them may be attained in the extruder. For drying them, for example, herein employable is a method of heating them in a heating furnace at 90° C. for at least 8 hours, which, however, is not limitative. For pelletization, the cellulose acylate and additives are melted in a double-screw extruder at 150° C. to 250° C., then extruded out as noodles, and they are solidified in water and pelletized. Also herein employable for pelletization is an underwater cutting method that comprises melting a polymer mixture in an extruder, followed by directly cutting the resulting melt in water immediately after extruded out through the extruder die into water.

The extruder may be any ordinary one in which a mixture can be fully melted and kneaded, including, for example, known single-screw extruders, non-engaging multi-directional double-screw extruders, engaging multi-directional double-screw extruders, engaging unidirectional double-screw extruders. Preferably, the size of the pellets is as follows: The cross section is from 1 mm² to 300 mm², and the length is from 1 mm to 30 mm; more preferably the cross section is from 2 mm² to 100 mm², and the length is from 1.5 mm to 10 mm.

In pelletization, the additives may be put into the extruder through the material take-in mouth or the vent mouth formed in the extruder.

Preferably, the number of revolution of the extruder is from 10 rpm to 1000 rpm, more preferably from 20 rpm to 700 rpm, more preferably from 30 rpm to 500 rpm. When the number of revolution is at least 10 rpm, then the thermal deterioration to cause molecular weight reduction or yellowing may be easy to prevent. When it is at most 1000 rpm, then the molecule breakage by shearing to cause molecular weight reduction or crosslinked gel formation may be easy to prevent.

The extruder retention time in pelletization is preferably from 10 seconds to 30 minutes, more preferably from 15 seconds to 10 minutes, even more preferably from 30 seconds to 3 minutes. So far as the polymer mixture can be well melted therein, the retention time in the extruder is preferably as short as possible for preventing the resin deterioration and yellowing.

(Concrete Method of Melt-Casting Film Formation)

Embodiments of melt-casting film formation are described below.

[1] Drying:

As the film-forming material to produce the cellulose acylate film of the invention, preferred are cellulose acylate pellets. Specifically, prior to melt-casting film formation, the pellets are dried to have a water content of at most 1%, more preferably at most 0.5%, and they are put into the hopper of a melt extruder. In this stage, the hopper is kept preferably at a temperature falling between (Tg −50° C.) and (Tg +30° C.), more preferably between (Tg −40° C.) and (Tg +10° C.), even more preferably between (Tg −30° C.) and Tg of cellulose acylate. In that condition, water is prevented from being re-adsorbed by the polymer in the hopper and the drying efficiency may be therefore higher.

[2] Kneading Extrusion:

Cellulose acylate is melt-kneaded preferably at 120° C. to 250° C., more preferably at 140° C. to 240° C., even more preferably at 150° C. to 230° C. In this stage, the melting temperature may be kept constant all the time, or may be varied to have a controlled temperature profile that varies in some sections. Preferably, the time for the melting operation is from 2 minutes to 60 minutes, more preferably from 3 minutes to 40 minutes, even more preferably from 4 minutes to 30 minutes. Further, it is also desirable that the inner atmosphere of the melt extruder is an inert gas (e.g., nitrogen) atmosphere, or a vented extruder is used while it is degassed into vacuum via its vent.

[3] Film Formation:

The resin melt extruded out through the die as a sheet according to the above-mentioned method is cooled and solidified on a casting drum to give a film. In this stage, preferably employed is an electrostatic charging method, an air knife method, an air chamber method, a vacuum nozzle method or a touch roll method, in which the adhesiveness between the casting drum and the melt-extruded sheet is increased. The adhesion improving method may be employed entirely or partly in the melt-extruded sheet. As the case may be, an edge pinning method may be employed in which the adhesiveness at only both edges of the film is increased, but the invention is not limited to the method.

It is desirable that plural casting drums are used for gradually cooling the film. In general, three cooling rolls are used, but the invention is not limited to the method. Preferably, the diameter of the roll is from 50 mm to 5000 mm, more preferably from 100 mm to 2000 mm, even more preferably from 150 mm to 1000 mm. The distance between the plural rolls is preferably from 0.3 mm to 300 mm, more preferably from 1 mm to 100 mm, even more preferably from 3 mm to 30 mm, in terms of the face to face distance therebetween.

Preferably, the temperature of the casting drum is from 60° C. to 160° C., more preferably from 70° C. to 150° C., even more preferably from 80° C. to 140° C. After the step, the film is peeled off from the casting drum, then led to nip rolls and wound up. The winding speed is preferably from 10 m/min to 100 m/min, more preferably from 15 m/min to 80 m/min, even more preferably from 20 m/min to 70 m/min.

The width of the film formed is preferably from 0.7 m to 5 m, more preferably from 1 m to 4 m, even more preferably from 1.3 m to 3 m. Thus obtained, the thickness of the unstretched film is preferably from 30 μm to 400 μm, more preferably from 40 μm to 300 μm, even more preferably from 50 μm to 200 μm.

In case where a touch roll method is employed herein, the touch roll surface may be formed of rubber or resins such as Teflon®, or the roll may be a metal roll. A flexible roll may be used herein, which is modified from a metal roll by reducing its thickness. When this is used, the roll surface is depressed in some degree owing to the touch pressure applied thereto, and therefore the contact area between the sheet and the roll is broadened.

The touch roll temperature is preferably from 60° C. to 160° C., more preferably from 70° C. to 150° C., even more preferably from 80° C. to 140° C.

The details of the touch roll method are described, for example, in JP-A-2004-216717, JP-A-2004-287418, JP-A-2004-50560, JP-A-2004-330651.

Preferably, the thus-obtained film is trimmed at both edges thereof and then wound up. The trimmed scraps may be ground, then optionally granulated, reprecipitated or depolymerized, and recycled as the starting material for the same type or a different type of films. Before wound up, it is also desirable that the film is laminated with an additional film on at least one surface thereof for preventing it from being scratched and damaged.

(Solution-Casting Film Formation Method)

Preferred embodiments of solution-casting film formation for the cellulose acylate film of the invention are described below.

In the invention, the solvent for cellulose acylate is not specifically defined so far as it may dissolve cellulose acylate to prepare a film-forming dope capable of being cast into films, and may attain the object of the invention. Preferred are chlorine-containing organic solvents such as dichloromethane, chloroform, 1,2-dichloroethane, tetrachloroethane, and chlorine-free organic solvents.

The chlorine-free organic solvents for use in the invention are preferably selected from esters, ketones and ethers having from 3 to 12 carbon atoms. The esters, the ketones and the ethers may have a cyclic structure. Compounds having two or more, same or different groups selected from esters (—COO—), ketones (—CO—) and ethers (—O—) are also usable herein as a main solvent. In case where the main solvent has two or more functional groups, or that is at least one functional group of esters, ketones and ethers as combined with any other functional group such as an alcoholic hydroxyl group, the number of the carbon atoms constituting it may fall within a range of the number of carbon atoms that constitute the compound having any of those functional groups. Examples of the esters having from 3 to 12 carbon atoms are ethyl formate, propyl formate, pentyl formate, methyl acetate, ethyl acetate, pentyl acetate. Examples of the ketones having from 3 to 12 carbon atoms are acetone, methyl ethyl ketone, diethyl ketone, methyl isobutyl ketone, diisobutyl ketone, cyclopentanone, cyclohexanone, methylcyclohexanone. Examples of the ethers having from 3 to 12 carbon atoms are diisopropyl ether, dimethoxymethane, dimethoxyethane, 1,4-dioxane, 1,3-dioxolane, tetrahydrofuran, anisole and phenetole. Examples of the organic solvents having plural functional groups are 2-ethoxyethyl acetate, 2-methoxyethanol, 2-butoxyethanol.

The chlorine-containing organic solvents for use in the invention are not specifically defined, so far as they may dissolve cellulose acylate to prepare a film-forming dope capable of being cast into films, and may attain the object of the invention. The chlorine-containing organic solvent is preferably dichloromethane, chloroform, more preferably dichloromethane. Also preferably, the chlorine-containing organic solvent may be combined with any other organic solvent than the chlorine-containing organic solvent. In case where dichloromethane is selected for the chlorine-containing organic solvent, then it is desirable that the solvent contains at least 50% by mass of dichloromethane.

Chlorine-free organic solvents that are preferably combined with the chlorine-containing organic solvent for use in the invention are mentioned below. The preferred chlorine-free organic solvents are those selected from esters, ketones and ethers having from 3 to 12 carbon atoms. The esters, the ketones and the ethers may have a cyclic structure. Compounds having two or more, same or different groups selected from esters (—COO—), ketones (—CO—) and ethers (—O—) are also usable herein as a main solvent. In case where the main solvent has two or more functional groups, or that is at least one functional group of esters, ketones and ethers as combined with any other functional group such as an alcoholic hydroxyl group, the number of the carbon atoms constituting it may fall within a range of the number of carbon atoms that constitute the compound having any of those functional groups. Examples of the esters having from 3 to 12 carbon atoms are ethyl formate, propyl formate, pentyl formate, methyl acetate, ethyl acetate, pentyl acetate. Examples of the ketones having from 3 to 12 carbon atoms are acetone, methyl ethyl ketone, diethyl ketone, methyl isobutyl ketone, diisobutyl ketone, cyclopentanone, cyclohexanone, methylcyclohexanone. Examples of the ethers having from 3 to 12 carbon atoms are diisopropyl ether, dimethoxymethane, dimethoxyethane, 1,4-dioxane, 1,3-dioxolane, tetrahydrofuran, anisole and phenetole. Examples of the organic solvents having two or more functional groups are 2-ethoxyethyl acetate, 2-methoxyethanol, 2-butoxyethanol.

The chlorine-containing organic solvent may be combined with an alcohol having from 1 to 12 carbon atoms. The alcohol may be linear, branched or cyclic. The hydroxyl group of the alcohol may be any of primary to tertiary groups. Preferred examples of the alcohol are methanol, ethanol, 1-propanol, 2-propanol, 1-butanol, 2-butanol, tert-butanol, 1-pentanol, 2-methyl-2-butanol and cyclohexanol. Fluoroalcohols (e.g., 2-fluoroethanol, 2,2,2-trifluoroethanol, 2,2,3,3-tetrafluoro-1-propanol, 1,1,1,3,3,3-hexafluoro-2-propanol) are also usable herein.

The chlorine-containing organic solvent may be combined with a hydrocarbon having from 5 to 22 carbon atoms. The hydrocarbon may be linear, branched or cyclic. Both aromatic hydrocarbons and aliphatic hydrocarbons are usable herein. The aliphatic hydrocarbons may be saturated or unsaturated. Examples of the hydrocarbons are cyclohexane, hexane, benzene, toluene and xylene.

Not specifically defined, the chlorine-free organic solvent that may be combined with the main solvent, chlorine-containing organic solvent is preferably selected from methyl acetate, ethyl acetate, methyl formate, ethyl formate, acetone, dioxolane, dioxane, ketones or acetacetates having from 4 to 7 carbon atoms, and alcohols or hydrocarbons having from 1 to 10 carbon atoms. More preferred are methyl acetate, acetone, methyl formate, ethyl formate, methyl ethyl ketone, cyclopentanone, cyclohexanone, methyl acetylacetate, methanol, ethanol, 1-propanol, 2-propanol, 1-butanol, 2-butanol, cyclohexanol, cyclohexane, hexane.

Preferably, the cellulose acylate of the invention is dissolved in the organic solvent to a degree of from 10 to 35% by mass, more preferably from 13 to 30% by mass, even more preferably from 15 to 28% by mass. In order to dissolve the cellulose acylate in the organic solvent to prepare a solution having the concentration that falls within the range, for example, employable is a method of dissolving it to have a desired concentration in the dissolution step, or a method of first preparing a low-concentration solution (for example, having a concentration of from 9 to 14% by mass) and then concentrating it into a high-concentration solution in the subsequent concentration step. Apart from these, also employable is a method comprising first preparing a high-concentration cellulose acylate solution and then adding various additives thereto to convert it into a low-concentration cellulose acylate solution having a predetermined low concentration. Any of these methods is employable in the invention with no specific limitation thereon so far as the cellulose acylate solution having a preferred concentration for use in the invention can be prepared.

The method of preparing the cellulose acylate solution (dope) in the invention is not specifically defined. For example, the solution may be prepared at room temperature, or according to a cooling dissolution method or a high-temperature dissolution method, or according to a combination of any of these. Methods for preparing cellulose acylate solution are described, for example, in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017, JP-A-11-302388. The methods of dissolving cellulose acylate in organic solvent described in these patent publications are suitably applicable to the invention, not overstepping the object of the invention. The details of the methods, especially the details of chlorine-free organic solvents are described in Hatsumei Kyokai Disclosure Bulletin (No. 2001-1745, published on Mar. 15, 2001 by the Hatsumei Kyokai), pp. 22-25. The dope solution of cellulose acylate in the invention is generally concentrated and filtered, and its details are also described in Hatsumei Kyokai Disclosure Bulletin (No. 2001-1745, published on Mar. 15, 2001 by the Hatsumei Kyokai), p. 25. When the polymer is dissolved at high temperatures, then the dissolving temperature is not lower than the boiling point of the organic solvent used in most cases, and in those cases, the system may be processed under pressure.

Preferably, the viscosity and the dynamic storage elastic modulus of the cellulose acylate solution in the invention are both within a predetermined range. The data may be determined as follows: One ml of a sample solution is prepared, and this is analyzed in a rheometer (CLS 500 by TA Instruments) equipped with Steel Cone (by TA Instruments) having a diameter of 4 cm/2°. Concretely, the sample is analyzed within a range of from 40° C. to −10° C., using Oscillation Step/Temperature Ramp varying at 2° C./min, and its static non-Newtonian viscosity n* (Pa·s) at 40° C. and its storage elastic modulus G′ (Pa) at −5° C. are determined. The sample solution is previously kept warmed at the start point temperature and kept constant at that temperature, and then tested. In the invention, it is desirable that the solution has a viscosity at 40° C. of from 1 to 400 Pa·s, and has a dynamic storage elastic modulus at 15° C. of at least 500 Pa; more preferably a viscosity at 40° C. of from 10 to 200 Pa·s, and a dynamic storage elastic modulus at 15° C. of from 100 to 1,000,000 Pa. Also preferably, the dynamic storage elastic modulus of the solution at low temperatures is as low as possible. For example, when the casting support is at −5° C., then the dynamic storage elastic modulus of the solution at −5° C. is preferably from 10,000 to 1,000,000 Pa; and when the support is at −50° C., then the dynamic storage elastic modulus of the solution at −50° C. is preferably from 10,000 to 5,000,000 Pa.

(Concrete Method of Solution-Casting Film Formation)

Concrete methods of solution-casting film formation for the cellulose acylate film of the invention are described below. Regarding the method and the equipment for producing the cellulose acylate film of the invention, any conventional solution-casting film formation methods and solution-casting film formation devices used for producing conventional cellulose acylate films are usable in the invention.

In one preferred embodiment, a dope (cellulose acylate solution) prepared in a dissolver (tank) is once stored in a storage tank, in which the dope is degassed to be a final dope. The dope is fed into a pressure die from the dope discharge port of the tank, via a metering pressure gear pump through which a predetermined amount of the dope can be fed with accuracy, for example, based on the controlled revolution thereof, and then the dope is uniformly cast onto the metal support of a casting unit that runs endlessly, via the slit of the pressure die. Then, at a peeling point at which the metal support reaches almost after having traveled round, a semi-dried dope film (this may be referred to as a web) is peeled from the metal support. Clipped at its both ends by clips to keep its cross width as such, the resulting web is dried while being conveyed with a tenter, then transported with rolls in the drying device, and after having thus wound, it is wound up with a winder to a predetermined length. The combination of the tenter and the drying device with rolls may be varied depending on the object of the method. In most cases of solution-casting film formation for silver halide photographic materials or functional protective films for electronic displays, additional coating devices may be added to the solution-casting film formation device, for surface processing of the films for forming an undercoat layer, an antistatic layer, an antihalation layer and a protective layer thereon. The processing steps are described in detail in Hatsumei Kyokai Disclosure Bulletin (No. 2001-1745, published on Mar. 15, 2001 by the Hatsumei Kyokai), pp. 25-30, as grouped into casting (including co-casting), metal support, drying, peeling, and stretching.

In the invention, the space temperature in the casting zone is not specifically defined, but it is preferably from −50 to 50° C., more preferably from −30 to 40° C., even more preferably from −20 to 30° C. Especially when the cellulose acylate solution is cast at a low space temperature, then it is instantaneously cooled on the support and its gel strength is increased thereon, and the support may hold the organic solvent-containing film thereon. Accordingly, without evaporation of the organic solvent from cellulose acylate, the film may be peeled off within a short period of time, and it enables high-speed casting film formation. Not specifically defined, ordinary air may be used for cooling the space, and apart from it, nitrogen, argon or helium may also be used for it. Preferably, the relative humidity in the space is from 0 to 70%, more preferably from 0 to 50%. In the invention, the temperature of the support on which the cellulose acylate solution is cast may be from −50 to 130° C., preferably from −30 to 25° C., more preferably from −20 to 15° C. In order that the temperature of the casting part could be kept within the temperature range in the invention, a cold vapor may be introduced into the casting zone, or a cooling device may be fitted to the casting zone so as to cool the space in the casting zone. In this stage, attention should be paid so as to prevent water adhesion to the casting zone, and a dry air may be used for cooling the casting zone.

Regarding the constitution of the layers of the film of the invention and the casting mode for the layers, their preferred embodiments are mentioned below. Preferably, the cellulose acylate solution contains at least one liquid or solid plasticizer in an amount of from 0.1 to 20% by mass of cellulose acylate therein at 25° C., and/or contains at least one liquid or solid UV absorbent in an amount of from 0.001 to 5% by mass of cellulose acylate, and/or contains at least one solid, fine particulate powder having a mean particle size of from 5 to 3000 nm, in an amount of from 0.001 to 5% by mass of cellulose acylate, and/or contains at least one fluorine-containing surfactant in an amount of from 0.001 to 2% by mass of the cellulose acylate, and/or contains at least one lubricant in an amount of from 0.0001 to 2% by mass of cellulose acylate, and/or contains at least one antioxidant in an amount of from 0.0001 to 2% by mass of cellulose acylate, and/or contains at least one anisotropy controller in an amount of from 0.1 to 15% by mass of cellulose acylate, and/or contains at lest one IR absorbent in an amount of from 0.1 to 5% by mass of cellulose acylate.

In the casting step, one cellulose acylate solution may be cast to form a single layer, or two or more cellulose acylate solutions may be co-cast simultaneously or successively to form a multi-layer film. In the co-casting step of forming a multi-layer film, the cellulose acylate solutions to be used and the cellulose acylate films formed of them may be characterized by the following: The composition of the chlorine-containing solvent for each layer is the same or different; one or more additives are added to each layer; the additive is added to a same one layer or to different layers; the concentration of the additive in the solution is the same in each layer, or differs in each layer; the associate molecular weight in each layer is the same or different; the temperature of the solution for each layer is the same or different; the amount of each coating layer is the same or different; the viscosity of each layer is the same or different; the dry thickness of each layer is the same or different; the material in each layer is distributed in the same manner or in a different manner; the physical properties of each layer are the same or different; the physical properties of each layer are uniform, or different physical properties are distributed in each layer. The physical properties as referred to herein include those described in detail in Hatsumei Kyokai Disclosure Bulletin (No. 2001-1745, published on Mar. 15, 2001 by the Hatsumei Kyokai), pp. 6-7, for example, haze, transmittance, spectral characteristics, retardation Re, retardation Rth, molecular alignment axis, axis shifting, tear strength, bending-resistant strength, tensile strength, winding inner and outer Rt difference, backlash, dynamic friction factor, alkali hydrolyzability, curl value, water content, residual solvent content, thermal shrinkage, high-moisture dimensional stability, moisture permeability, base planarity, dimensional stability, thermal shrinkage-starting temperature, elastic modulus, and brightening spot impurities, and these physical properties of the film of the invention are measured. In addition, the yellowness index, the transparency and the thermal physical properties (Tg, heat for crystallization) of cellulose acylate as in Hatsumei Kyokai Disclosure Bulletin (No. 2001-1745, published on Mar. 15, 2001 by the Hatsumei Kyokai), p. 11 may also be measured.

(Stretching)

The cellulose acylate film of the invention, thus produced according to the melt-casting film formation method or the solution-casting film formation method mentioned above, is preferably stretched for the purpose of improving the surface condition thereof, expressing Re and Rth thereof, and improving the linear expansion coefficient thereof.

During the film formation process, the film may be stretched in an on-line mode, or after the film has been formed, it may be once wound up and then stretched in an off-line mode. Specifically, in the melt-casting film formation method, the film formed may be stretched before or after it has been completely cooled.

Preferably, the film is stretched at a temperature falling between Tg and (Tg +50° C.), more preferably between (Tg +1° C.) and (Tg +30° C.), even more preferably between (Tg +2° C.) and (Tg +20° C.). Also preferably, the draw ratio for the stretching is from 0.1 to 500%, more preferably from 10 to 300%, even more preferably from 30 to 200%. The stretching may be effected in one stage or in multiple stages. The draw ratio may be obtained according to the following formula:
Draw Ratio(%)=100×{(length after stretching)−(length before stretching)}/(length before stretching).

The stretching may be effected in a mode of machine-direction stretching or cross-direction stretching or their combination. The MD stretching includes (1) roll stretching (using at least two pairs of nip rolls of which the speed of the roll on the take-out side is kept higher, the film is stretched in the machine direction), (2) edge fixed stretching (both edges of the film are fixed, and the film is stretched by conveying it in the machine direction gradually at an elevated speed in the machine direction). The cross-direction stretching may be tenter stretching (both edges of the film are held with a chuck, and the film is expanded and stretched in the cross direction (in the direction perpendicular to the machine direction)). The machine-direction stretching and the cross-direction stretching may be effected either alone (monoaxial stretching) or may be combined (biaxial stretching. In the biaxial stretching, the machine-direction stretching and the cross-direction stretching may be effected successively (successive stretching) or simultaneously (simultaneous stretching).

Both in the machine-direction stretching and the cross-direction stretching, the stretching speed is preferably from 10%/min to 10000%/min, more preferably from 20%/min to 1000%/min, even more preferably from 30%/min to 800%/min. In the multi-stage stretching, the stretching speed is the mean value of the stretching speed in each stage.

After thus stretched in the manner as above, it is desirable that the film is relaxed in the machine direction or in the cross direction by from 0% to 10%. Further, after thus stretched, it is also desirable that the film is thermally fixed at 150° C. to 250° C. for 1 second to 3 minutes.

After thus stretched, the thickness of the film is preferably from 10 to 300 μm, more preferably from 20 μm to 200 μm, even more preferably from 30 μm to 100 μm.

Re of the cellulose acylate film of the invention is preferably from 0 nm to 300 nm, more preferably from 10 nm to 250 nm, even more preferably from 20 nm to 200 nm. Rth of the film is preferably from −200 nm to 500 nm, more preferably from −150 nm to 400 nm, even more preferably from 0 nm to 350 nm.

Re and Rth of the film are preferably Re<Rth, more preferably Re×1.5<Rth, even more preferably Re<Rth×2. The film having such Re and Rth can be obtained by edge-fixed monoaxial stretching, more preferably by biaxial stretching in both the machine direction and the cross direction. This is because, when the film is stretched in both the machine direction and the cross direction, then the difference between the in-plane refractivity (nx, ny) may be reduced and Re may be thereby reduced, and further, since the film is stretched in both the machine direction and the cross direction to thereby enlarge the area thereof, the alignment in the thickness direction may be enhanced with the reduction in the thickness of the thus-stretched film, therefore resulting in the increase in Rth. Having such Re and Rth, the film is effective for further reducing the light leakage at the time of black level of displays.

Preferably, the angle Θ formed by the film-traveling direction (machine direction) and the slow axis of Re of the film is nearer to 0°, +90° or −90°. Concretely, in machine-direction stretching, the angle is preferably nearer to 0°, more preferably to 0±3°, even more preferably to 0±2°, still more preferably to 0±10. In cross-direction stretching, the angle is preferably 90±3° or −90±3°, more preferably 90±2° or −90±2°, even more preferably 90±10 or −90±10.

In this description, the retardation value Re and the retardation value Rth are calculated as follows: Re(λ) and Rth(λ) are an in-plane retardation and a thickness direction retardation, respectively, of a film at a wavelength of λ. Re(λ) is determined by applying light having a wavelength of λ nm to a film in the normal direction of the film, using KOBRA 21ADH (by Oji Scientific Instruments). Rth(λ) is determined as follows: Based on three retardation data determined in three different directions, or that is, Re(λ) as above, a retardation value measured by applying light having a wavelength of λ nm to the sample in the direction tilted by +40° relative to the normal direction of the film with the slow axis (judged by KOBRA 21ADH) as the tilt axis (rotation axis) thereof, and a retardation value measured by applying light having a wavelength of λ nm to the sample in the direction tilted by −40° relative to the normal direction of the film with the slow axis as the tilt axis thereof, Rth(λ) is computed by KOBRA 21ADH. For this, an estimated value of the mean refractivity of the film and the film thickness must be inputted to the instrument. nx, ny and nz are also computed by KOBRA 21ADH in addition to Rth(λ). The mean refractivity of cellulose acylate is 1.48; and the data of some other polymer films than cellulose acetate for optical use are as follows: Cyclo-olefin polymer (1.52), polycarbonate (1.59), polymethyl methacrylate (1.49), polystyrene (1.59). For the mean refractivity data of still other already-existing polymer materials, referred to are the numerical data in Polymer Handbook (by John Wiley & Sons, Inc.) or those in polymer film catalogues. When the mean refractivity of the sample is unknown, it may be measured with an Abbe's refractiometer. Unless otherwise specifically indicated, λ in this description is at 550±5 nm o at 590±5 nm.

The above-mentioned, unstretched or stretched cellulose acylate film may be used either alone or as combined with a polarizer; and a liquid-crystal layer or a layer having a controlled refractivity (low-refractivity layer) or a hard coat layer may be provided on it for use herein.

(Photoelasticity Coefficient)

The cellulose acylate film of the invention is preferably used as a protective film for polarizer or as a retardation plate. In case where the film is used as a protective film for polarizer or as a retardation plate, then its birefringence (Re, Rth) may vary owing to its expansion through moisture absorption or to its stress through shrinkage. The birefringence change through stress of the film may be determined as the photoelasticity coefficient thereof, and its range is preferably from 5×10⁻⁷ (cm²/kgf) to 30×10⁻⁷ (cm²/kgf), more preferably from 6×10⁻⁷ (cm²/kgf) to 25×10⁻⁷ (cm²/kgf), even more preferably from 7×10⁻⁷ (cm²/kgf) to 20×10⁻⁷ (cm²/kgf),

(Surface Treatment)

The unstretched or stretched cellulose acylate film of the invention may be optionally subjected to surface treatment to thereby improve the adhesiveness between the cellulose acylate film and various functional layers (e.g., undercoat layer, back layer) adjacent thereto. The surface treatment is, for example, glow discharge treatment, UV irradiation treatment, corona treatment, flame treatment, or acid or alkali treatment. The glow discharge treatment as referred to herein may be low-temperature plasma treatment to be effected under a low gas pressure of from 10-3 to 20 Torr (0.13 to 2.7×10³ Pa), or may be plasma treatment under atmospheric pressure. The plasma-exciting vapor to be used in the plasma treatment is a vapor that is excited by plasma under the condition as above. The plasma-exciting vapor includes, for example, argon, helium, neon, krypton, xenon, nitrogen, carbon dioxide, flons such as tetrafluoromethane, and their mixtures. Their details are described in Hatsumei Kyokai Disclosure Bulletin (No. 2001-1745, published by the Hatsumei Kyokai on Mar. 15, 2001), pp. 30-32. For the plasma treatment under atmospheric pressure that has become specifically noted recently, preferably used is irradiation energy of from 20 to 500 kGy under 10 to 1000 kev, more preferably from 20 to 300 kGy under 30 to 500 kev. Of the above-mentioned treatments, more preferred is alkali saponification, and this is extremely effective for the surface treatment of cellulose acylate films.

For the alkali saponification, the film to be processed may be dipped in a saponification solution or may be coated with it. In the dipping method, a cellulose acylate film may be led to pass through a tank of an aqueous NaOH or KOH solution having a pH of from 10 to 14 at 20 to 80° C., taking 0.1 minutes to 10 minutes, and then neutralized, washed with water and dried.

When the alkali saponification is attained according to a coating method, employable for it are a dip-coating method, a curtain-coating method, an extrusion-coating method, a bar-coating method and an E-type coating method. The solvent for the alkali saponification coating solution is preferably so selected that the saponification solution comprising it may well wet a transparent support to which the solution is applied, and that the solvent does not roughen the surface of the transparent support and may keep the support having a good surface condition. Concretely, alcohol solvents are preferred, and isopropyl alcohol is more preferred. An aqueous solution of surfactant may also be used as the solvent. The alkali to be in the alkali saponification coating solution is preferably an alkali soluble in the above-mentioned solvent. More preferably, it is KOH or NaOH. The pH of the saponification coating solution is preferably at least 10, more preferably at least 12. The alkali saponification time is preferably from 1 second to 5 minutes at room temperature, more preferably from 5 seconds to 5 minutes, even more preferably from 20 seconds to 3 minutes. After the alkalis saponification treatment, it is desirable that the saponification solution-coated surface of the film is washed with water or with an acid and then further washed with water. If desired, the coating saponification treatment may be effected continuously with the alignment film removal treatment that will be mentioned hereinunder. In that manner, the number of the processing steps in producing the film may be decreased. Concretely, for example, the saponification method is described in JP-A-2002-82226 and WO02/46809, and this may be employed herein.

Preferably, the cellulose acylate film of the invention is provided with an undercoat layer for improving the adhesiveness thereof to the functional layers to be formed thereon. The undercoat layer may be formed on the cellulose acylate film after the above-mentioned surface treatment, or may be directly formed on the film with no surface treatment. The details of the undercoat layer are described in Hatsumei Kyokai Disclosure Bulletin (No. 2001-1745, published on Mar. 15, 2001 by the Hatsumei Kyokai), p. 32.

The step of surface treatment and undercoat layer formation may be carried out singly or as combined with the last step in the process of film formation. Further, the step may also be carried out along with the step of forming the functional groups to be mentioned hereinunder.

<Combination with Functional Group>

Preferably, the cellulose acylate film of the invention is combined with functional layers described in detail in Hatsumei Kyokai Disclosure Bulletin (No. 2001-1745, published on Mar. 15, 2001 by the Hatsumei Kyokai), pp. 32-45. Above all, it is desirable that the film is provided with a polarizing layer (for polarizer), an optically-compensatory layer (for optically-compensatory sheet) and an antireflection layer (for antireflection film).

[Polarizing Film]

(Material of Polarizing Film)

At present, one general method of producing commercially-available polarizing films comprises dipping a stretched polymer in a solution containing iodine or dichroic dye in a bath to thereby infiltrate iodine or dichroic dye into the binder. As the polarizing film, a coated polarizing film such as typically that by Optiva Inc. may be utilized.

Iodine and dichroic dye in the polarizing film are aligned in the binder and express the polarization property. The dichroic dye includes azo dyes, stilbene dyes, pyrazolone dyes, triphenylmethane dyes, quinoline dyes, oxazine dyes, thiazine dyes and anthraquinone dyes. Preferably, the dichroic dye for use herein is soluble in water. Also preferably, the dichroic dye has a hydrophilic substituent (e.g., sulfo, amino, hydroxyl). For example, the compounds described in Hatsumei Kyokai Disclosure Bulletin (No. 2001-1745, published on Mar. 15, 2001 by the Hatsumei Kyokai), p. 58 may be used as the dichroic dye herein.

For the binder for the polarizing film, usable are a polymer that is crosslinkable by itself, and a polymer that is crosslinkable with a crosslinking agent. These polymers may be combined for use herein. The binder includes, for example, methacrylate copolymers, styrene copolymers, polyolefins, polyvinyl alcohols, modified polyvinyl alcohols, poly(N-methylolacrylamides), polyesters, polyimides, vinyl acetate copolymers, carboxymethyl cellulose and polycarbonates, as in JP-A-8-338913, [0022]. In addition, a silane coupling agent may also be used as the polymer.

Above all, water-soluble polymers (e.g., poly(N-methylolacrylamide), carboxymethyl cellulose, gelatin, polyvinyl alcohol, modified polyvinyl alcohol) are preferred; gelatin, polyvinyl alcohol and modified polyvinyl alcohol are more preferred; and polyvinyl alcohol and modified polyvinyl alcohol are even more preferred. Especially preferably, two different types of polyvinyl alcohols or modified polyvinyl alcohols having a different degree of polymerization are combined for use herein. Preferably, the degree of saponification of polyvinyl alcohol for use herein is from 70 to 100%, more preferably from 80 to 100%.

Also preferably, the degree of polymerization of polyvinyl alcohol is from 100 to 5000.

Modified polyvinyl alcohols are described in JP-A-8-338913, JP-A-9-152509 and JP-A-9-316127. Two or more different types of polyvinyl alcohols and modified polyvinyl alcohols may be combined for use herein. Preferably, the lowermost limit of the thickness of the binder is 10 μm. Regarding the uppermost limit of the thickness thereof, it is preferably thinner from the viewpoint of the light leakage resistance thereof in liquid-crystal display devices. Concretely, for example, it is desirable that the thickness of the polarizing film is not larger than the same level as that of currently commercially-available polarizers (about 30 μm), more preferably it is at most 25 μm, even more preferably at most 20 μm.

The binder of the polarizing film may be crosslinked. A polymer or a monomer having a crosslinking functional group may be incorporated into the binder, or the binder polymer may be so designed that it has a crosslinking functional group. The crosslinking may be attained through exposure to light or heat or through pH change, and it gives a binder having a crosslinked structure therein. The crosslinking agent is described in US Reissue Pat. No. 23,297. A boron compound (e.g., boric acid, borax) may also be used as a crosslinking agent. The amount of the crosslinking agent to be added to the binder is preferably from 0.1 to 20% by mass of the binder. Within the range, the alignment of the polarizer element and the wet heat resistance of the polarizing film are both good.

After the crosslinking reaction, it is desirable that the amount of the unreacted crosslinking agent still remaining in the polarizing film is at most 1.0% by mass, more preferably at most 0.5% by mass. Within the range, the polarizing film may have good weather resistance.

(Stretching of Polarizing Film)

Preferably, the polarizing film is stretched (according to a stretching process) or rubbed (according to a rubbing process), and then dyed with iodine or dichroic dye.

In the stretching process, the draw ratio is preferably from 2.5 to 30.0 times, more preferably from 3.0 to 10.0 times. The stretching may be attained in dry in air. Contrary to this, the stretching may also be attained in wet while the film is dipped in water. Preferably, the draw ratio in dry stretching is from 2.5 to 5.0 times, and the draw ratio in wet stretching is from 3.0 to 10.0 times. The draw ratio in stretching as referred to herein is (length of polarizing film after stretched/length of polarizing film before stretched). The stretching may be attained in parallel to the MD direction (parallel stretching) or in the direction oblique to the MD direction (oblique stretching). The stretching may be effected once, or a few times. When the stretching is effected a few times, then the film may be more uniformly stretched even at a high draw ratio. Preferably, the film is stretched obliquely in the direction inclined by from 10 degrees to 80 degrees relative to the MD direction.

(a) Parallel stretching method:

Before stretched, PVA film is swollen. The degree of swelling of the film is from 1.2 to 2.0 times (in terms of the ratio by mass of the swollen film to the unswollen film). Next, the film is continuously conveyed via guide rolls, and led into a bath of an aqueous medium or into a dyeing bath of a dichroic substance solution. In the bath, in general, the film is stretched at a bath temperature of from 15 to 50° C., preferably from 17 to 40° C. The stretching may be effected by holding the film with two pairs of nip rolls, and the conveying speed of the latter-stage nip rolls is kept higher than that of the former-stage nip rolls. In view of the above-mentioned effects and advantages, the draw ratio in stretching (ratio of the length of stretched film/length of initial film—the same shall apply hereinunder) is preferably from 1.2 to 3.5 times, more preferably from 1.5 to 3.0 times. Next, the stretched film is dried at 50 to 90° C. to be a polarizing film.

(b) Oblique stretching method:

For the oblique stretching method employable herein, referred to is the method described in JP-A-2002-86554. The method comprises using a tenter tensed in the direction oblique to the machine direction, and stretching a film with it. The stretching is effected in air, and therefore the film to be stretched must be previously watered so as to facilitate its stretching. Preferably, the water content of the watered film is from 5 to 100%, more preferably from 10 to 100%.

Preferably, the temperature in stretching is from 40 to 90° C., more preferably from 50 to 80° C. Also preferably, the humidity in stretching is from 50 to 100% RH, more preferably from 70 to 100% RH, even more preferably from 80 to 100% RH. The film traveling speed in the machine direction in stretching is preferably at least 1 m/min, more preferably at least 3 m/min.

After thus stretched, the film is then dried preferably at 50 to 100° C., more preferably at 60 to 90° C., preferably for 0.5 to 10 minutes, more preferably for 1 to 5 minutes.

Preferably, the absorption axis of the polarizing film thus obtained is from 100 to 800, more preferably from 300 to 600, even more preferably substantially 45° (40° to 50°).

(Lamination)

The saponified cellulose acylate film is laminated with a polarizing film prepared by stretching to thereby construct a polarizer. The direction in which the two are laminated is preferably so controlled that the casting axis direction of the cellulose acylate film crosses the stretching axis direction of the polarizer at an angle of 45 degrees.

Not specifically defined, the adhesive for the lamination may be an aqueous solution of a PVA resin (including modified PVA with any of acetoacetyl group, sulfonic acid group, carboxyl group or oxyalkylene group) or a boron compound. Above all, preferred are PVA resins. The thickness of the adhesive layer is preferably from 0.01 to 10 μm, more preferably from 0.05 to 5 μm, after dried.

The light transmittance of the thus-obtained polarizer is preferably higher, and the degree of polarization thereof is also preferably higher. Concretely, the transmittance of the polarizer preferably falls between 30 and 50% for the light having a wavelength of 550 nm, more preferably between 35 and 50%, even more preferably between 40 and 50%. The degree of polarization of the polarizer preferably falls between 90 and 100% for the light having a wavelength of 550 nm, more preferably between 95 and 100%, even more preferably between 99 and 100%.

Further, the thus-constructed polarizer may be laminated with a λ/4 plate to form a circularly-polarizing plate. In this case, the two are so laminated that the slow axis of the λ/4 plate meets the absorption axis of the polarizer at an angle of 45 degrees. In this, the λ/4 plate is not specifically defined but preferably has a wavelength dependency of such that its retardation is smaller at a lower wavelength. Further, it is also desirable to use a λ/4 plate that comprises a polarizing film of which the absorption axis is inclined by 20 to 70° relative to the machine direction and an optically-anisotropic layer of a liquid-crystalline compound.

[Formation of Optically-Compensatory Layer (construction of optically-compensatory sheet)]

An optically-compensatory layer is for compensating the liquid-crystalline compound in a liquid-crystal cell at the time of black level of display in liquid-crystal display devices, and this may be constructed by forming an alignment film on a cellulose acylate film followed by further forming thereon an optically-anisotropic layer.

(Alignment Film)

An alignment film is provided on the cellulose acylate film that has been processed for surface treatment as above. The film has the function of defining the alignment direction of liquid-crystal molecules. However, if a liquid-crystalline compound can be aligned and then its alignment state can be fixed as such, then the alignment film is not indispensable as a constitutive element, and may be therefore omitted as not always needed. In this case, only the optically-anisotropic layer on the alignment film of which the alignment state has been fixed may be transferred onto a polarizing element to construct a polarizer film that comprises the cellulose acylate film of the invention

The alignment film may be formed, for example, through rubbing treatment of an organic compound (preferably polymer), oblique vapor deposition of an inorganic compound, formation of a microgrooved layer, or accumulation of an organic compound (e.g., ω-tricosanoic acid, dioctadecylmethylammonium chloride, methyl stearate) according to a Langmuir-Blodgett's method (LB film). Further, there are known other alignment films that may have an alignment function through impartation of an electric field or magnetic field thereto or through light irradiation thereto.

In this invention, the alignment film is preferably formed through rubbing treatment of a polymer. In principle, the polymer to be used for the alignment film has a molecular structure that has the function of aligning liquid-crystalline molecules.

Preferably, the polymer for use in the invention has crosslinking functional group (e.g., double bond)-having side branches bonded to the backbone chain thereof or has a crosslinking functional group having the function of aligning liquid-crystalline molecules introduced into the side branches thereof, in addition to having the function of aligning liquid-crystalline molecules.

The polymer to be used for the alignment film may be a polymer that is crosslinkable by itself or a polymer that is crosslinkable with a crosslinking agent, or may also be a combination of the two. Examples of the polymer are methacrylate copolymers, styrene copolymers, polyolefins, polyvinyl alcohols and modified polyvinyl alcohols, poly(N-methylolacrylamides), polyesters, polyimides, vinyl acetate copolymers, carboxymethyl cellulose and polycarbonates, as in JP-A-8-338913, [0022]. A silane coupling agent is also usable as the polymer. Preferably, the polymer is a water-soluble polymer (e.g., poly(N-methylolacrylamide), carboxymethyl cellulose, gelatin, polyvinyl alcohol, modified polyvinyl alcohol), more preferably gelatin, polyvinyl alcohol or modified polyvinyl alcohol, even more preferably polyvinyl alcohol or modified polyvinyl alcohol. Especially preferably, two different types of polyvinyl alcohols or modified polyvinyl alcohols having a different degree of polymerization are combined for use as the polymer. Preferably, the degree of saponification of polyvinyl alcohol for use herein is from 70 to 100%, more preferably from 80 to 100%. Also preferably, the degree of polymerization of polyvinyl alcohol is from 100 to 5000.

The side branches having the function of aligning liquid-crystalline molecules generally have a hydrophobic group as the functional group. Concretely, the type of the functional group may be determined depending on the type of the liquid-crystalline molecules to be aligned and on the necessary alignment state of the molecules.

For example, the modifying group of modified polyvinyl alcohol may be introduced into the polymer through copolymerization modification, chain transfer modification or block polymerization modification. Examples of the modifying group are a hydrophilic group (e.g., carboxylic acid group, sulfonic acid group, phosphonic acid group, amino group, ammonium group, amido group, thiol group), a hydrocarbon group having from 10 to 100 carbon atoms, a fluorine atom-substituted hydrocarbon group, a thioether group, a polymerizing group (e.g., unsaturated polymerizing group, epoxy group, aziridinyl group), and an alkoxysilyl group (e.g., trialkoxy group, dialkoxy group, monoalkoxy group). Specific examples of such modified polyvinyl alcohol compounds are described, for example, in JP-A-2000-155216, [0022] to [0145], and in JP-A-2002-62426, [0018] to [0022].

When crosslinking functional group-having side branches are bonded to the backbone chain of an alignment film polymer, or when a crosslinking functional group is introduced into the side chains of a polymer having the function of aligning liquid-crystalline molecules, then the polymer of the alignment film may be copolymerized with the polyfunctional monomer in an optically-anisotropic layer. As a result, not only between the polyfunctional monomers but also between the alignment film polymers, and even between the polyfunctional monomer and the alignment film polymer, they may be firmly bonded to each other in a mode of covalent bonding to each other. Accordingly, introducing such a crosslinking functional group into an alignment film polymer significantly improves the mechanical strength of the resulting optically-compensatory sheet.

Preferably, the crosslinking functional group of the alignment film polymer contains a polymerizing group, like the polyfunctional monomer. Concretely, for example, those described in JP-A-2000-155216, [0080] to [0100] are referred to herein. Apart from the above-mentioned crosslinking functional group, the alignment film polymer may also be crosslinked with a crosslinking agent.

The crosslinking agent includes, for example, aldehydes, N-methylol compounds, dioxane derivatives, compounds capable of being active through activation of the carboxyl group thereof, active vinyl compounds, active halide compound, isoxazoles and dialdehyde starches. Two or more different types of crosslinking agents may be combined for use herein. Concretely, for example, the compounds described in JP-A-2002-62426, [0023] to [0024] are employable herein. Preferred are aldehydes of high reactivity, and more preferred is glutaraldehyde.

Preferably, the amount of the crosslinking agent to be added to polymer is from 0.1 to 20% by mass of the polymer, more preferably from 0.5 to 15% by mass. Also preferably, the amount of the unreacted crosslinking agent that may remain in the alignment film is at most 1.0% by mass, more preferably at most 0.5% by mass. When the crosslinking agent in the alignment film is controlled to that effect, then the film ensures good durability with no reticulation even though it is used in liquid-crystal display devices for a long period of time and even though it is left in a high-temperature high-humidity atmosphere for a long period of time.

Basically, the alignment film may be formed by applying the alignment film-forming material of the above-mentioned polymer to a crosslinking agent-containing transparent support, then heating and drying it (for crosslinking it) and then rubbing the thus-formed film. The crosslinking reaction may be effected in any stage after the film-forming material has been applied onto the transparent support, as so mentioned hereinabove. When a water-soluble polymer such as polyvinyl alcohol is used as the alignment film-forming material, then it is desirable that the solvent for the coating solution is a mixed solvent of a defoaming organic solvent (e.g., methanol) and water. The ratio by mass of water/methanol preferably falls between 0/100 and 99/1, more preferably between 0/100 and 91/9. The mixed solvent of the type is effective for preventing the formation of bubbles in the coating solution and, as a result, the surface defects of the alignment film and even the optically-anisotropic layer are greatly reduced.

For forming the alignment film, preferably employed is a spin-coating method, a dip-coating method, a curtain-coating method, an extrusion-coating method, a rod-coating method or a roll-coating method. Especially preferred is a rod-coating method. Also preferably, the thickness of the film is from 0.1 to 10 μm, after dried. The drying under heat may be effected at 20 to 110° C. For sufficient crosslinking, the heating temperature is preferably from 60 to 100° C., more preferably from 80 to 100° C. The drying time may be from 1 minute to 36 hours, but preferably from 1 to 30 minutes. The pH of the coating solution is preferably so defined that it is the best for the crosslinking agent used. For example, when glutaraldehyde is used, the pH of the coating solution is preferably from 4.5 to 5.5, more preferably pH 5.

The alignment film is provided on the transparent support or on the undercoat layer. The alignment film may be formed by crosslinking the polymer layer as above, and then rubbing the surface of the layer.

For the rubbing treatment, usable is any method widely employed for liquid crystal alignment treatment in producing liquid-crystal display devices. Concretely, for example, the surface of the alignment film is rubbed in a predetermined direction by the use of paper, gauze, felt, rubber, nylon, or polyester fibers, whereby the film may be aligned in the intended direction. In general, a cloth uniformly planted with fibers having the same length and the same thickness is used, and the surface of the film is rubbed a few times with the cloth.

On an industrial scale, the operation may be attained by contacting a rolling rubbing roll to a polarizing layer-having film that is traveling in the system. Preferably, the circularity, the cylindricity, and the deflection (eccentricity) of the rubbing roll are all at most 30 μm each. Also preferably, the lapping angle of the film around the rubbing roll is from 0.1 to 90°. However, the film may be lapped at an angle of 360° or more for stable rubbing treatment, as in JP-A-8-160430. Preferably, the film traveling speed is from 1 to 100 m/min. The rubbing angle may fall between 0 and 60°, and it is desirable that a suitable rubbing angle is selected within the range. When the film is used in liquid-crystal display devices, the rubbing angle is preferably from 40 to 50°, more preferably 45°.

The thickness of the alignment film thus obtained is preferably from 0.1 to 10 μm.

<Optically-Anisotropic Layer>

Next, an optically-anisotropic layer is formed on the alignment film, and the liquid-crystalline molecules in the layer are aligned. Then, if desired, the alignment film polymer is reacted with the polyfunctional monomer in the optically-anisotropic layer, or the alignment film polymer is crosslinked with a crosslinking agent.

The liquid-crystalline molecules in the optically-anisotropic layer include rod-shaped liquid-crystalline molecules and discotic liquid-crystalline molecules. The rod-shaped liquid-crystalline molecules and the discotic liquid-crystalline molecules may be high-molecular liquid crystals or low-molecular liquid crystals. In addition, they include crosslinked low-molecular liquid crystals that do not exhibit liquid crystallinity.

1) Rod-Shaped Liquid-Crystalline Molecules:

The rod-shaped liquid-crystalline molecules are preferably azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolanes and alkenylcyclohexylbenzonitriles.

The rod-shaped liquid-crystalline molecules include metal complexes. Liquid-crystal polymers that contain rod-shaped liquid-crystalline molecules in the repetitive units are also usable herein as the rod-shaped liquid-crystalline molecules. In other words, the rod-shaped liquid-crystalline molecules for use herein may bond to (liquid-crystal) polymer.

Rod-shaped liquid-crystalline molecules are described in Quarterly Journal of General Chemistry, Vol. 22, Liquid Crystal Chemistry (1994), Chaps. 4, 7 and 11, edited by the Chemical Society of Japan; Liquid Crystal Devices Handbook, edited by the 142nd Committee of the Nippon Academic Promotion, Chap. 3.

The birefringence of the rod-shaped liquid-crystalline molecule preferably falls between 0.001 and 0.7.

Preferably, the rod-shaped liquid-crystalline molecules have a polymerizing group for fixing their alignment state. The polymerizing group is preferably a radical-polymerizing unsaturated group or a cationic polymerizing group. Concretely, for example, there are mentioned the polymerizing groups and the polymerizing liquid-crystal compounds described in JP-A-2002-62427, [0064] to [0086].

2) Discotic Liquid-Crystalline Molecules:

The discotic liquid-crystalline molecules include, for example, benzene derivatives as in C. Destrade et al's study report, Mol. Cryst., Vol. 71, p. 111 (1981); truxene derivatives as in C. Destrade et al's study report, Mol. Cryst., Vol. 122, p. 141 (1985), Physics Lett. A., Vol. 78, p. 82 (1990); cyclohexane derivatives as in B. Kohne et al's study report, Angew. Chem., Vol. 96, p. 70 (1984); and azacrown-type or phenylacetylene-type macrocycles as in J. M. Lehn et al's study report, J. Chem. Commun., p. 1794 (1985), J. Zhang et al's study report, J. Am. Chem. Soc., Vol. 116, p. 2655 (1994).

The discotic liquid-crystalline molecules include liquid-crystalline compounds in which the molecular center nucleus is radially substituted with side branches of a linear alkyl, alkoxy or substituted benzoyloxy group. Preferably, the molecules or the molecular aggregates of the compounds are rotary-symmetrical and may undergo certain alignment. It is not always necessary that, in the optically-anisotropic layer formed of such discotic liquid-crystalline molecules, the compounds that are finally in the optically-anisotropic layer are discotic liquid-crystalline molecules. For example, low-molecular discotic liquid-crystalline molecules may have a group capable of being reactive when exposed to heat or light, and as a result, they may polymerize or crosslink through thermal or optical reaction to give high-molecular compounds with no liquid crystallinity. In the invention, the optically-anisotropic layer may contain such a high-molecular, non-liquid crystalline compound. Preferred examples of the discotic liquid-crystalline molecules are described in JP-A-8-50206. Polymerization of discotic liquid-crystalline molecules is described in JP-A-8-27284.

For fixing the discotic liquid-crystalline molecules through polymerization, the discotic core of the discotic liquid-crystalline molecules must be substituted with a polymerizing group. Preferably, the polymerizing group bonds to the discotic core via a linking group. Accordingly, the compounds of the type may keep their alignment state even after their polymerization. For example, there are mentioned the compounds described in JP-A-2000-155216, [0151] to [0168].

In hybrid alignment, the angle between the major axis (disc plane) of the discotic liquid-crystalline molecules and the plane of the polarizing film increases or decreases with the increase in the distance from the plane of the polarizing film in the depth direction of the optically-anisotropic layer. Preferably, the angle decreases with the increase in the distance. The angle change may be in any mode of continuous increase, continuous decrease, intermittent increase, intermittent decrease, change including continuous increase and continuous decrease, or intermittent change including increase and decrease. The intermittent change includes a region in which the tilt angle does not change in the midway of the thickness direction. The angle may include a region with no angle change so far as it increases or decreases as a whole. Preferably, the angle continuously varies.

The mean direction of the major axis of the discotic liquid-crystalline molecules on the polarizing film side may be controlled generally by suitably selecting the material of the discotic liquid-crystalline molecules or that of the alignment film or by suitably selecting the rubbing treatment method. The direction of the major axis of the discotic liquid-crystalline molecules (disc plane) on the surface side (on the external air side) may be controlled generally by suitably selecting the material of the discotic liquid-crystalline molecules or that of the additive to be used along with the discotic liquid-crystalline molecules. Examples of the additive that may be used along with the discotic liquid-crystalline molecules include, for example, plasticizer, surfactant, polymerizing monomer and polymer. Like in the above, the degree of the change of the major axis in the alignment direction may also be controlled by suitably selecting the liquid-crystalline molecules and the additive.

(Other Composition of Optically-Anisotropic Layer)

Along with the above-mentioned liquid-crystalline molecules, a plasticizer, a surfactant, a polymerizing monomer and others may be added to the optically-anisotropic layer for improving the uniformity of the coating film, the strength of the film and the alignment of the liquid-crystalline molecules on the film. Preferably, the additives have good compatibility with the liquid-crystalline molecules that constitute the layer and may have some influence on the tilt angle change of the liquid-crystalline molecules, not interfering with the alignment of the molecules.

The polymerizing monomer includes radical-polymerizing or cationic-polymerizing compounds. Preferred are polyfunctional radical-polymerizing monomers. Also preferred are those copolymerizable with the above-mentioned, polymerizing group-containing liquid-crystal compounds. For example, herein mentioned are the compounds described in JP-A-2002-296423, [0018] to [0020]. The amount of the compound to be added to the layer may be generally from 1% by mass to 50% by mass of the discotic liquid-crystalline molecules in the layer, but preferably from 5% by mass to 30% by mass.

The surfactant may be any known one, but is preferably a fluorine-containing compound. Concretely, for example, there are mentioned the compounds described in JP-A-2001-330725, [0028] to [0056].

The polymer that may be used along with the discotic liquid-crystalline molecules is preferably one capable of changing the tilt angle of the discotic liquid-crystalline molecules.

Examples of the polymer are cellulose acylates. Preferred examples of cellulose acylates are described in JP-A-2000-155216, [0178]. So as not to interfere with the alignment of the liquid-crystalline molecules in the layer, the amount of the polymer to be added to the layer is preferably from 0.1% by mass to 10% by mass of the liquid-crystalline molecules, more preferably from 0.1% by mass to 8% by mass.

Preferably, the discotic nematic liquid-crystal phase/solid phase transition temperature of the discotic liquid-crystalline molecules falls between 70 and 300° C., more preferably between 70 and 170° C.

(Formation of Optically-Anisotropic Layer)

The optically-anisotropic layer may be formed by applying a coating solution that contains liquid-crystalline molecules and optionally a polymerization initiator and other optional components mentioned below, on the alignment film.

The solvent to be used in preparing the coating solution is preferably an organic solvent. Examples of the organic solvent are amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane, tetrachloroethane), esters (e.g., methyl acetate, butyl acetate), ketones (e.g., acetone, methyl ethyl ketone), ethers (e.g., tetrahydrofuran, 1,2-dimethoxyethane). Of those, preferred are alkyl halides and ketones. Two or more such organic solvents may be used as combined.

The coating solution may be applied onto the alignment film in any known method (e.g., wire bar coating, extrusion coating, direct gravure coating, reverse gravure coating, die coating).

The thickness of the optically-anisotropic layer is preferably from 0.1 to 20 μm, more preferably from 0.5 to 15 μm, even more preferably from 1 to 10 μm.

(Fixation of Alignment State of Liquid-Crystalline Molecules)

The aligned liquid-crystalline molecules may be fixed as they are in alignment state. Preferably, the fixation is effected through polymerization. The polymerization includes thermal polymerization with a thermal polymerization initiator and optical polymerization with an optical polymerization initiator. Preferred is optical polymerization.

The optical polymerization initiator includes, for example, α-carbonyl compounds (as in U.S. Pat. Nos. 2,367,661, 2,367,670), acyloin ethers (as in U.S. Pat. No. 2,448,828), α-hydrocarbon-substituted aromatic acyloin compounds (as in U.S. Pat. No. 2,722,512), polynuclear quinone compounds (as in U.S. Pat. Nos. 3,046,127, 2,951,758), combination of triarylimidazole dimer and p-aminophenylketone (as in U.S. Pat. No. 3,549,367), acridine compounds and phenazine compounds (as in JP-A-60-105667, U.S. Pat. No. 4,239,850), and oxadiazole compounds (as in U.S. Pat. No. 4,212,970).

The amount of the optical polymerization initiator to be added is preferably from 0.01 to 20% by mass of the solid content of the coating solution, more preferably from 0.5 to 5% by mass.

Preferably, UV rays are used for light irradiation for polymerization of liquid-crystalline molecules.

Preferably, the irradiation energy falls within a range of from 20 to 50 mJ/cm², more preferably from 20 to 5000 mJ/cm², even more preferably from 100 to 800 mJ/cm². For promoting the optical polymerization, the light irradiation may be effected under heat.

A protective layer may be provided on the optically-anisotropic layer.

(Combination with Polarizing Film)

Preferably, the optically-compensatory film is combined with a polarizing film. Concretely, the above-mentioned optically-anisotropic layer-coating solution is applied onto the surface of a polarizing film to from an optically-anisotropic layer thereon. As a result, no polymer film exists between the polarizing film and the optically-anisotropic layer, and a thin polarizer is thus constructed of which the stress (strain ×cross section ×elasticity) to be caused by the dimensional change of the polarizing film is reduced. When the polarizer that comprises the cellulose acylate film of the invention is fitted to large-size liquid-crystal display devices, then it does not produce a problem of light leakage and the devices can display high-quality images.

Preferably, the polarizing film and the optically-compensatory layer are so stretched that the tilt angle between the two may correspond to the angle formed by the transmission axis of the two polarizers to be stuck to both sides of the liquid crystal cell to constitute LCD, and the machine direction or the cross direction of the liquid crystal cells. In general, the tilt angle is 45°. Recently, however, some devices in which the tile angle is not 45° have been developed for transmission-type, reflection-type or semi-transmission-type LCDs, and it is desirable that the stretching direction is varied in any desired manner depending on the plan of LCDs.

[Formation of Antireflection Layer (Construction of Antireflection Film)]

In general, an antireflection film is constructed by forming a low-refractivity layer that functions as a stain-preventing layer, and at least one layer having a higher refractivity than the low-refractivity layer (high-refractivity layer or middle-refractivity layer) on a transparent substrate.

A multi-layer film is formed by laminating transparent thin films of inorganic compounds (e.g., metal oxides) having a different refractivity, for example, in a mode of chemical vapor deposition (CVD) or physical vapor deposition (PVD); or a film of colloidal metal oxide particles is formed according to a sol-gel process with a metal compound such as a metal oxide, and then this is post-treated (e.g., UV irradiation as in JP-A-9-157855, or plasma treatment as in JP-A-2002-327310) to give a thin film.

On the other hand, various types of antireflection films of high producibility are proposed, which are formed by laminating thin films of inorganic particles dispersed in a matrix. The antireflection films produced according to the above-mentioned coating methods may be further processed so that the surface of the outermost layer thereof is roughened to have an antiglare property.

The cellulose acylate film of the invention may be applied to any type of the antireflection films mentioned hereinabove. Especially preferably, the film is applied to antireflection films constructed in a layers-coating system (layers-coated antireflection films).

(Layer Constitution of Layers-Coated Antireflection Film)

The antireflection film having a layer constitution of at least a middle-refractivity layer, a high-refractivity layer and a low-refractivity layer (outermost layer) formed in that order on a substrate is so planned that it satisfies the refractivity profile mentioned below.

Refractivity of high-refractivity layer > refractivity of middle-refractivity layer > refractivity of transparent support > refractivity of low-refractivity layer.

A hard coat layer may be disposed between the transparent support and the middle-refractivity layer. Further, the layers-coated antireflection film may comprise a middle-refractivity hard coat layer, a high-refractivity layer and a low-refractivity layer. For example, JP-A-8-122504, JP-A-8-110401, JP-A-10-300902, JP-A-2002-243906, JP-A-2000-111706 are referred to.

The constitutive layers may have other functions. For example, there are mentioned a stain-resistant low-refractivity layer and an antistatic high-refractivity layer (as in JP-A-10-206603, JP-A-2002-243906).

Preferably, the haze of the antireflection film is at most 5%, more preferably at most 3%. Also preferably, the strength of the film is at least H measured in the pencil hardness test according to JIS K5400, more preferably at least 2H, most preferably at least 3H.

(High-Refractivity Layer and Middle-Refractivity Layer)

The high-refractivity layer of the antireflection film is formed of a cured film that contains at least ultrafine particles of an inorganic compound of high refractivity having a mean particle size of at most 100 nm and a matrix binder.

The high-refractivity inorganic compound particles are those of an inorganic compound having a refractivity of at least 1.65, preferably at least 1.9. The inorganic compound particles are, for example, those of a metal oxide with any of Ti, Zn, Sb, Sn, Zr, Ce, Ta, La and In, and those of a composite oxide with such metal atoms.

For example, the ultrafine particles may be processed with a surface-treating agent (e.g., silane coupling agent as in JP-A-11-295503, JP-A-11-153703, JP-A-2000-9908; anionic compound or organic metal coupling agent as in JP-A-2001-310432); or they may have a core/shell structure in which the core is a high-refractivity particle (e.g., as in JP-A-2001-166104); or they may be combined with a specific dispersant (e.g., as in JP-A-11-153703, U.S. Pat. No. 6,210,858B1, JP-A-2002-2776069). The material to from the matrix may be any known thermoplastic resin or curable resin film.

For the material, preferred is at least one composition selected from a polyfunctional compound-containing composition in which the compound has at least two radical-polymerizing and/or cationic-polymerizing groups, and a composition of a hydrolyzing group-containing organic metal compound or its partial condensate. For it, for example, referred to are the compounds described in JP-A-2000-47004, JP-A-2001-315242, JP-A-2001-31871, JP-A-2001-296401.

Also preferred is a curable film formed of a colloidal metal oxide obtained from a hydrolyzed condensate of a metal alkoxide, and a metal alkoxide composition. For example, it is described in JP-A-2001-293818.

The refractivity of the high-refractivity layer is generally from 1.70 to 2.20. Preferably, the thickness of the high-refractivity layer is from 5 nm to 10 μm, more preferably from 10 nm to 1 μm.

The refractivity of the middle-refractivity layer is so controlled that it may be between the refractivity of the low-refractivity layer and that of the high-refractivity layer. Preferably, the refractivity of the middle-refractivity layer is from 1.50 to 1.70.

(Low-Refractivity Layer)

The low-refractivity layer is laminated on the high-refractivity layer in order. The refractivity of the low-refractivity layer may be from 1.20 to 1.55, but preferably from 1.30 to 1.50.

Preferably, the low-refractivity layer is constructed as the outermost layer having good scratch resistance and good stain resistance. For increasing the scratch resistance of the layer, it is effective to lubricate the surface of the layer. For it, for example, employable is a method of forming a thin layer that contains a conventional silicone compound or fluorine-containing compound introduced thereinto.

Preferably, the refractivity of the fluorine-containing compound is from 1.35 to 1.50, more preferably from 1.36 to 1.47. Also preferably, the fluorine-containing compound has a crosslinking or polymerizing functional group that contains a fluorine atom in an amount of from 35 to 80% by mass.

For example, herein usable are the compounds described in JP-A-9-222503, [0018] to [0026]; JP-A-11-38202, [0030] to [0030]; JP-A-2001-40284, [0027] to [0028]; and JP-A-2000-284102.

Preferably, the silicone compound has a polysiloxane structure in which the polymer chain contains a curable functional group or a polymerizing functional group, and it forms a film having a crosslinked structure therein. For example, it includes reactive silicones (e.g., Silaplane (from Chisso), and polysiloxanes double-terminated with a silanol group (as in JP-A-11-258403).

Preferably, the crosslinking or polymerizing group-having, fluorine-containing and/or siloxane polymer in the outermost layer is crosslinked or polymerized simultaneously with or after the coating operation with the coating composition to form the outermost layer that contains a polymerization initiator and a sensitizer, by exposing the coating layer to light or heat.

Also preferred is a sol-gel curable film which comprises an organic metal compound such as a silane coupling agent and a specific fluorine-containing hydrocarbon group-having silane coupling agent and in which they are condensed in the presence of a catalyst to cure the film.

For example, there are mentioned a polyfluoroalkyl group-containing silane compound or its partial hydrolyzed condensate (as in JP-A-58-142958, JP-A-58-147483, JP-A-58-147484, JP-A-9-157582, JP-A-11-106704), and a silyl compound having a fluorine-containing long-chain group, poly(perfluoroalkylether) group (as in JP-A-2000-117902, JP-A-2001-48590, JP-A-2002-53804).

As other additives than the above, the low-refractivity layer may contain a filler (e.g., low-refractivity inorganic compound of which the primary particles have a mean particle size of from 1 to 150 nm, such as silicon dioxide (silica), fluorine-containing particles (magnesium fluoride, calcium fluoride, barium fluoride); organic fine particles described in JP-A-11-3820, [0020] to [0038]), a silane coupling agent, a lubricant, a surfactant, etc.

When the low-refractivity layer is positioned below the outermost layer, then it may be formed according to a vapor-phase process (e.g., vacuum evaporation, sputtering, ion plating, plasma CVD). However, a coating method is preferred as it produces the layer at low costs.

Preferably, the thickness of the low-refractivity layer is from 30 to 200 nm, more preferably from 50 to 150 nm, most preferably from 60 to 120 nm.

(Hard Coat Layer)

The hard coat layer may be disposed on the surface of a transparent support for increasing the physical strength of the antireflection film to be thereon. In particular, the layer is preferably disposed between a transparent support and the above-mentioned high-refractivity layer.

Also preferably, the hard coat layer is formed through crosslinking or polymerization of an optical and/or thermal curable compound. The curable functional group is preferably a photopolymerizing functional group, and the hydrolyzing functional group-containing organic metal compound is preferably an organic alkoxysilyl compound.

Specific examples of the compounds may be the same as those mentioned hereinabove for the high-refractivity layer.

Specific examples of the constitutive composition for the hard coat layer are described in, for example, JP-A-2002-144913, JP-A-2000-9908, and WO00/46617.

The high-refractivity layer may serve also as a hard coat layer. In such a case, it is desirable that fine particles are added to and finely dispersed in the hard coat layer in the same manner as that mentioned hereinabove for the formation of the high-refractivity layer.

Containing particles having a mean particle size of from 0.2 to 10 μm, the hard coat layer may serve also as an antiglare layer (this will be mentioned hereinunder) having an antiglare function.

The thickness of the hard coat layer may be suitably determined in accordance with the use of the antireflection film. Preferably, for example, the thickness of the hard coat layer is from 0.2 to 10 μm, more preferably from 0.5 to 7 μm.

Preferably, the strength of the hard coat layer is at least H as measured in the pencil hardness test according to JIS K5400, more preferably at least 2H, even more preferably at least 3H. Also preferably, the abrasion of the test piece of the layer before and after the taper test according to JIS K5400 is as small as possible.

(Front-Scattering Layer)

A front-scattering layer may be provided in the antireflection film. This is for improving the viewing angle on the upper and lower sides and on the right and left sides of liquid-crystal display devices to which the film is applied. Fine particles having a different refractivity may be dispersed in the hard coat layer, and the resulting hard coat layer may serve also as a front-scattering layer.

For it, for example, referred to are JP-A-11-38208 in which the front-scattering coefficient is specifically defined; JP-A-2000-199809 in which the relative refractivity of transparent resin and fine particles is defined to fall within a specific range; and JP-A-2002-107512 in which the haze value is defined to be at least 40%.

(Other Layers)

In addition to the above-mentioned layers, the film may further has a primer layer, an antistatic layer, an undercoat layer, a protective layer, etc.

(Coating Method)

The constitutive layers of the antireflection film may be formed in various coating methods of, for example, dip coating, air knife coating, curtain coating, roller coating, wire bar coating, gravure coating, microgravure coating or extrusion coating (as in U.S. Pat. No. 2,681,294).

(Antiglare Function)

The antireflection film may have an antiglare function of scattering external light. The film may have the antiglare function by roughening its surface. When the antireflection film has the antiglare function, then its haze is preferably from 3 to 30%, more preferably from 5 to 20%, most preferably from 7 to 20%.

For roughening the surface of the antireflection film, employable is any method in which the roughened surface profile may be kept well. For example, there are mentioned a method of adding fine particles to a low-refractivity layer so as to roughen the surface of the layer (e.g., as in JP-A-2000-271878); a method of adding a small amount (from 0.1 to 50% by mass) of relatively large particles (having a particle size of from 0.05 to 2 μm) to the lower layer (high-refractivity layer, middle-refractivity layer or hard coat layer) below a low-refractivity layer to thereby roughen the surface of the lower layer, and forming a low-refractivity layer on it while keeping the surface profile of the lower layer (e.g., as in JP-A-2000-281410, JP-A-2000-95893, JP-A-2001-100004, JP-A-2001-281407); and a method of physically transferring a roughened profile onto the surface of the outermost layer (stain-resistant layer) (for example, according to embossing treatment as in JP-A-63-278839, JP-A-11-183710, JP-A-2000-275401).

<Liquid-Crystal Display Device>

The cellulose acylate film of the invention, and the polarizer, the retardation film and the optical film comprising the cellulose acylate film of the invention may be preferably built in liquid-crystal display devices. Various liquid-crystal modes of the devices are described below.

(TN-mode Liquid-Crystal Display Device)

A TN-mode is most popularly utilized in color TFT liquid-crystal display devices, and this is described in a large number of references. The alignment state in the liquid-crystal cell at the time of black level of TN-mode display is as follows: The rod-shaped liquid-crystalline molecules stand up in the center of the cell, and they lie down at around the substrate of the cell.

(OCB-Mode Liquid-Crystal Display Device)

This is a bent-alignment mode liquid-crystal cell in which the rod-shaped liquid-crystalline molecules are aligned substantially in the opposite directions (symmetrically) between the upper part and the lower part of the liquid-crystal cell. The liquid-crystal display device that comprises such a bent-alignment mode liquid-crystal cell is disclosed in U.S. Pat. Nos. 4,583,825 and 5,410,422. In this, since the rod-shaped liquid-crystalline molecules are symmetrically aligned in the upper part and the lower part of the liquid-crystal cell, the bent-alignment mode liquid-crystal cell has a self-optically-compensatory function. Accordingly, the liquid-crystal mode of the type is referred to as an OCB (optically-compensatory bent) liquid-crystal mode.

Regarding the alignment state at the time of black level of display in the OCB-mode liquid-crystal cell, the rod-shaped liquid-crystalline molecules stand up in the center of the cell, and they lie down at around the substrate of the cell, like in the TN-mode liquid-crystal cell.

(VA-Mode Liquid-Crystal Display Device)

This is characterized in that the rod-shaped liquid-crystalline molecules therein are substantially vertically aligned in the absence of voltage application thereto. The VA-mode liquid-crystal cell includes (1) a VA-mode liquid-crystal cell in the narrow sense of the word, in which the rod-shaped liquid-crystalline molecules are substantially vertically aligned in the absence of voltage application thereto but are substantially horizontally aligned in the presence of voltage application thereto (as in JP-A-2-176625), further including in addition to it, (2) a multi-domain VA-mode (MVA-mode) liquid crystal cell for viewing angle expansion (as in SID97, Digest of Tech. Papers (preprint), 28 (1997) 845), (3) an n-ASM-mode liquid-crystal cell in which the rod-shaped liquid-crystalline molecules are substantially vertically aligned in the absence of voltage application thereto but are subjected to twisted multi-domain alignment in the presence of voltage application thereto (as in the preprint in the Nippon Liquid Crystal Discussion Meeting, 58-59 (1998)), and (4) a SURVAIVAL-mode liquid-crystal cell (as announced in LCD International 98).

(IPS-Mode Liquid-Crystal Display Device)

This is characterized in that the rod-shaped liquid-crystalline molecules therein are substantially horizontally aligned in plane in the absence of voltage application thereto and that the alignment direction of the liquid crystals is varied depending on the presence or absence of voltage application thereto. Concretely, herein employable are those described in JP-A-2004-365941, JP-A-2004-12731, JP-A-2004-215620, JP-A-2002-221726, JP-A-2002-55341, JP-A-2003-195333.

(Other Liquid-Crystal Display Devices)

ECB-mode and STN-mode liquid-crystal display devices may be optically compensated in the same consideration as above.

### EXAMPLES

The characteristics of the invention are described more concretely with reference to the following Examples and Comparative Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

(Determination of Substitution Degree)

About 10 mg of a sample dried at 120° C. for 1 hour is dissolved in 0.5 ml of heavy chloroform, and subjected to ¹H-NMR (Bruker's AV-400 nuclear magnetic resonance device). In this, from the relation between the area strength of acetyl group and other acyl group than it, and the area strength of pyranose ring-derived proton, the degree of acyl substitution of the sample is obtained.

(Determination of Mean Molecular Weight)

A sample is dissolved in tetrahydrofuran to have a concentration of 0.5%, and subjected to GPC (Toso's HLC-8220GPC device, columns: TSKGEL Super HZM-M, HZ4000, HZ2000, HZ-L, detection: R1). As the standard substance, used is TSK's polystyrene, and the mean molecular weight of the sample is determined according to a relative method.

(Observation of Insoluble Matter)

A sample is dissolved in dichloromethane to have a concentration of 20%. This is cast on a glass plate to form a film thereon with the clearance being so controlled that the dry film thickness could be 80 μm. After dried, the film is cut into a piece of 2.5 cm×2.5 cm, and observed with a 100-power polarization microscope under a cross-Nicol condition, and the amount per mm² of the insoluble matter seen in the same piece to cause light leakage is determined.

### Example 1

### Production of Cellulose Acetate Propionate P-1

200 parts by mass of cellulose (wood pulp) and 121 parts by mass of acetic acid were put into a reactor equipped with a stirring device and a cooling device, and stirred at 60° C. for 4 hours to thereby activate the cellulose. 166 parts by mass of acetic anhydride, 1040 parts by mass of propionic acid, 1475 parts by mass or propionic anhydride and 14 parts by mass of sulfuric acid were stirred, cooled to −20° C. and added to the reactor.

The cellulose in the reactor was esterified in such a manner that the maximum reaction temperature could be 19.5° C., and the time at which the unreacted cellulose disappeared was considered as the end point of the reaction. The disappearance of the unreacted cellulose was confirmed by sampling the reaction mixture on a preparation glass sheet and observing it with a polarization microscope (the same shall apply hereinunder). The reaction was so controlled that the temperature of the reaction mixture at the end point could be 10° C. In this stage, about 10 g of the reaction mixture was sampled, added to an aqueous acetic acid solution for reprecipitation, washed with warm water and dried, and the mean molecular weight of the product was determined through GPC. The product had a number-average molecular weight of 104000 and a weight-average molecular weight of 263000.

A mixture of 367 parts by mass of water and 733 parts by mass of acetic acid was prepared as a reaction stopper, and this was cooled to −5° C., and added to the reaction mixture so that the temperature of the reaction mixture could not be over 23° C. The time taken for this was 1 hour. The reaction liquid was sampled, and the mean molecular weight of the product was determined in the same manner as that before stopping the reaction. In this stage, the product has a number-average molecular weight of 103000 and a weight-average molecular weight of 259000.

The reaction mixture was kept at 60° C. and stirred for 2 hours for partial hydrolysis. This was mixed with an aqueous acetic acid solution, and the resulting polymer compound was reprecipitated, and repeatedly washed with hot water at 70 to 80° C. After dewatered, this was dipped in an aqueous 0.005 mas % calcium hydroxide solution, stirred for 30 minutes and then again dewatered. Dried at 70° C., cellulose acetate propionate P-1 was obtained.

The thus-obtained cellulose acetate propionate P-1 had a degree of acetyl substitution of 0.72, a degree of propionyl substitution of 2.10, an overall degree of acyl substitution of 2.82, a number-average molecular weight of 96000 and a weight-average molecular weight of 254000. A film cast from a dichloromethane solution of this sample was observed with a polarization microscope, which showed little insoluble matter.

### Example 2

### Production of Cellulose Acetate Propionate P-2

200 parts by mass of cellulose (linter) and 100 parts by mass of acetic acid were put into a reactor equipped with a stirring device and a cooling device, and stirred at 60° C. for 4 hours to thereby activate the cellulose. 2060 parts by mass of propionic anhydride and 14 parts by mass of sulfuric acid were mixed, cooled to −20° C., and then added to the reactor.

The cellulose in the reactor was esterified in such a manner that the maximum reaction temperature could be 22.5° C., and the time at which the unreacted cellulose disappeared was considered as the end point of the reaction. The reaction was so controlled that the temperature of the reaction mixture at the end point could be 10° C. In this stage, about 10 g of the reaction mixture was sampled, added to an aqueous acetic acid solution for reprecipitation, washed with warm water and dried, and the mean molecular weight of the product was determined through GPC. The product had a number-average molecular weight of 121000 and a weight-average molecular weight of 303000.

A mixture of 353 parts by mass of water and 1059 parts by mass of acetic acid was prepared as a reaction stopper, and this was cooled to −5° C., and added to the reaction mixture so that the temperature of the reaction mixture could not be over 23° C. The time taken for this was 1 hour. The reaction liquid was sampled, and the mean molecular weight of the product was determined in the same manner as that before stopping the reaction. In this stage, the product has a number-average molecular weight of 122000 and a weight-average molecular weight of 305000.

The reaction mixture was kept at 40° C. and stirred for 0.5 hours for partial hydrolysis. This was mixed with an aqueous acetic acid solution, and the resulting polymer compound was reprecipitated, and repeatedly washed with hot water at 70 to 80° C. After dewatered, this was dipped in an aqueous 0.005 mas % calcium hydroxide solution, stirred for 30 minutes and then again dewatered. Dried at 70° C., cellulose acetate propionate P-2 was obtained.

The thus-obtained cellulose acetate propionate P-2 had a degree of acetyl substitution of 0.26, a degree of propionyl substitution of 2.66, an overall degree of acyl substitution of 2.92, a number-average molecular weight of 119000 and a weight-average molecular weight of 302000. A film cast from a dichloromethane solution of this sample was observed with a polarization microscope, which showed little insoluble matter.

### Example 3

### Production of Cellulose Acetate Butyrate B-1

200 parts by mass of cellulose (wood pulp) and 100 parts by mass of acetic acid were put into a reactor equipped with a stirring device and a cooling device, and stirred at 60° C. for 4 hours to thereby activate the cellulose. 161 parts by mass of acetic acid, 449 parts by mass of acetic anhydride, 742 parts by mass of butyric acid, 1349 parts by mass of butyric anhydride and 14 parts by mass of sulfuric acid were mixed, cooled to −35° C., and then added to the reactor.

The cellulose in the reactor was esterified in such a manner that the maximum reaction temperature could be 17.5° C., and the time at which the unreacted cellulose disappeared was considered as the end point of the reaction. The reaction was so controlled that the temperature of the reaction mixture at the end point could be 10° C. In this stage, about 10 g of the reaction mixture was sampled, added to an aqueous acetic acid solution for reprecipitation, washed with warm water and dried, and the mean molecular weight of the product was determined through GPC. The product had a number-average molecular weight of 123000 and a weight-average molecular weight of 326000.

A mixture of 297 parts by mass of water and 558 parts by mass of acetic acid was prepared as a reaction stopper, and this was cooled to −50° C., and added to the reaction mixture so that the temperature of the reaction mixture could not be over 230° C. The time taken for this was 1 hour. The reaction liquid was sampled, and the mean molecular weight of the product was determined in the same manner as that before stopping the reaction. In this stage, the product has a number-average molecular weight of 122000 and a weight-average molecular weight of 317000.

The reaction mixture was kept at 600° C. and stirred for 1 hour for partial hydrolysis. This was mixed with an aqueous acetic acid solution, and the resulting polymer compound was reprecipitated, and repeatedly washed with hot water at 70 to 800° C. After dewatered, this was dipped in an aqueous 0.005 mas % calcium hydroxide solution, stirred for 30 minutes and then again dewatered. Dried at 700° C., cellulose acetate butyrate B-1 was obtained.

The thus-obtained cellulose acetate butyrate B-1 had a degree of acetyl substitution of 1.66, a degree of butyryl substitution of 1.25, an overall degree of acyl substitution of 2.91, a number-average molecular weight of 118000 and a weight-average molecular weight of 308000. A film cast from a dichloromethane solution of this sample was observed with a polarization microscope, which showed little insoluble matter.

### Example 4

### Production of Cellulose Acetate Butyrate B-2

100 parts by mass of cellulose (linter) and 180 parts by mass of acetic acid were put into a reactor equipped with a stirring device and a cooling device, and stirred at 600° C. for 4 hours to thereby activate the cellulose. 960 parts by mass of butyric anhydride and 3 parts by mass of sulfuric acid were mixed, cooled to −20° C., and then added to the reactor.

The cellulose in the reactor was esterified in such a manner that the maximum reaction temperature could be 17.5° C., and the time at which the unreacted cellulose disappeared was considered as the end point of the reaction. The reaction was so controlled that the temperature of the reaction mixture at the end point could be 10° C. In this stage, about 10 g of the reaction mixture was sampled, added to an aqueous acetic acid solution for reprecipitation, washed with warm water and dried, and the mean molecular weight of the product was determined through GPC. The product had a number-average molecular weight of 115000 and a weight-average molecular weight of 282000.

A mixture of 153 parts by mass of water and 457 parts by mass of acetic acid was prepared as a reaction stopper, and this was cooled to −5° C., and added to the reaction mixture so that the temperature of the reaction mixture could not be over 20° C. The time taken for this was 1 hour. The reaction liquid was sampled, and the mean molecular weight of the product was determined in the same manner as that before stopping the reaction. In this stage, the product has a number-average molecular weight of 113000 and a weight-average molecular weight of 282000.

The reaction mixture was kept at 60° C. and stirred for 1.5 hours for partial hydrolysis. This was mixed with an aqueous acetic acid solution, and the resulting polymer compound was reprecipitated, and repeatedly washed with hot water at 70 to 80° C. After dewatered, this was dipped in an aqueous 0.005 mas % calcium hydroxide solution, stirred for 30 minutes and then again dewatered. Dried at 70° C., cellulose acetate butyrate B-2 was obtained.

The thus-obtained cellulose acetate butyrate B-2 had a degree of acetyl substitution of 1.11, a degree of butyryl substitution of 1.77, an overall degree of acyl substitution of 2.88, a number-average molecular weight of 106000 and a weight-average molecular weight of 273000. A film cast from a dichloromethane solution of this sample was observed with a polarization microscope, which showed little insoluble matter.

### Example 5

### Production of Cellulose Acetate Propionate P-3

0.1 parts by mass of acetic acid and 2.7 parts by mass of propionic acid were sprayed over 10 parts by mass of cellulose (broadleaf wood pulp), and stored at room temperature for 1 hour. Apart from this, a mixture of 1.2 parts by mass of acetic anhydride, 61 parts by mass of propionic anhydride and 0.7 parts by mass of sulfuric acid was prepared, cooled to −10° C., and mixed with the above pretreated cellulose in the reactor. After 30 minutes, the external temperature around the reactor was elevated up to 30° C., and the reaction was continued for 4 hours.

About 10 g of the reaction solution was sampled, added to an aqueous acetic acid solution for reprecipitation, washed with warm water and dried. The mean molecular weight of the product was determined through GPC. In this stage, the product had a number-average molecular weight of 55400 and a weight-average molecular weight of 138400.

46 parts by weight of 25% hydrous acetic acid was prepared as a reaction stopper, cooled to −5° C., and added to the reaction mixture while the reaction device was cooled so that the temperature of the reaction mixture could not be over 23° C. The time taken for this was 20 minutes. The reaction liquid was sampled, and the mean molecular weight of the product was determined in the same manner as that before stopping the reaction. In this stage, the product has a number-average molecular weight of 55300 and a weight-average molecular weight of 137900.

The inner temperature of the reactor was elevated up to 60° C., and this was stirred for 2 hours. 6.2 parts by mass of a mixture prepared by mixing magnesium acetate 4-hydrate, acetic acid and water in a ratio of 1/1/1 was added to it, and stirred for 30 minutes. The reaction liquid was filtered under pressure through metal-sintered filters each having a retention particle size or 40 μm, 10 μm and 5 μm in that order to remove impurities. After thus filtered, the reaction liquid was mixed with 75% hydrous acetic acid to thereby precipitate cellulose acetate propionate, which was then washed with hot water at 70° C. until the pH of the wash waste could be from 6 to 7. Then, this was stirred in an aqueous 0.001% calcium hydroxide solution for 0.5 hours, and filtered. The thus-obtained cellulose acetate propionate was dried at 70° C., and this is cellulose acetate propionate P-3.

Analyzed through ¹H-NMR thereof, the cellulose acetate propionate P-3 had a degree of acetyl substitution of 0.15, a degree of propionyl substitution of 2.62, an overall degree of acyl substitution of 2.77, a number-average molecular weight of 54500 (number-average degree of polymerization DPn=173), a weight-average molecular weight of 132000 (weight-average degree of polymerization DPw=419), a residual sulfuric acid content of 45 ppm, a magnesium content of 8 ppm, a calcium content of 46 ppm, a sodium content of 1 ppm, a potassium content of 1 ppm, and an iron content of 2 ppm. A film cast from a dichloromethane solution of this sample was observed with a polarization microscope, which showed little insoluble matter even in both cases where the polarizing elements were set perpendicular to each other or in parallel to each other.

### Comparative Example 1

### Production of Cellulose Acetate Propionate P-10

200 parts by mass of cellulose (wood pulp) and 121 parts by mass of acetic acid were put into a reactor equipped with a stirring device and a cooling device, and stirred at 60° C. for 4 hours to thereby activate the cellulose. 166 parts by mass of acetic anhydride, 1040 parts by mass of propionic acid, 1475 parts by mass or propionic anhydride and 14 parts by mass of sulfuric acid were stirred, cooled to −20° C. and added to the reactor.

The cellulose in the reactor was esterified in such a manner that the maximum reaction temperature could be 19.5° C., and the time at which the unreacted cellulose disappeared was considered as the end point of the reaction. The reaction was so controlled that the temperature of the reaction mixture at the end point could be 10° C. In this stage, about 10 g of the reaction mixture was sampled, added to an aqueous acetic acid solution for reprecipitation, washed with warm water and dried, and the mean molecular weight of the product was determined through GPC. The product had a number-average molecular weight of 105000 and a weight-average molecular weight of 266000.

A mixture of 367 parts by mass of water and 733 parts by mass of acetic acid was prepared as a reaction stopper, and this was cooled to −5° C., and added to the reaction mixture, taking 12 minutes. The temperature of the reaction mixture rose up to 55° C. owing to the generation of heat by hydrolysis of the acid anhydride. The reaction liquid was sampled, and the mean molecular weight of the product was determined in the same manner as that before stopping the reaction. In this stage, the product has a number-average molecular weight of 73000 and a weight-average molecular weight of 199000.

After the addition of the reaction stopper thereto, the reaction mixture was kept at 60° C. and stirred for 2 hours for partial hydrolysis. This was mixed with an aqueous acetic acid solution, and the resulting polymer compound was reprecipitated, and repeatedly washed with hot water at 70 to 80° C. After dewatered, this was dipped in an aqueous 0.005 mas % calcium hydroxide solution, stirred for 30 minutes and then again dewatered. Dried at 70° C., cellulose acetate propionate P-10 was obtained.

The thus-obtained cellulose acetate propionate P-10 had a degree of acetyl substitution of 0.70, a degree of propionyl substitution of 2.08, an overall degree of acyl substitution of 2.78, a number-average molecular weight of 71000 and a weight-average molecular weight of 184000. A film cast from a dichloromethane solution of this sample was observed with a polarization microscope, which showed little insoluble matter.

### Comparative Example 2

### Production of Cellulose Acetate Butyrate B-10

100 parts by mass of cellulose (linter) and 180 parts by mass of acetic acid were put into a reactor equipped with a stirring device and a cooling device, and stirred at 60° C. for 4 hours to thereby activate the cellulose. 960 parts by mass of butyric anhydride and 3 parts by mass of sulfuric acid were mixed, cooled to −20° C., and then added to the reactor.

The cellulose in the reactor was esterified in such a manner that the maximum reaction temperature could be 17.5° C., and the time at which the unreacted cellulose disappeared was considered as the end point of the reaction. The reaction was so controlled that the temperature of the reaction mixture at the end point could be 10° C. In this stage, about 10 g of the reaction mixture was sampled, added to an aqueous acetic acid solution for reprecipitation, washed with warm water and dried, and the mean molecular weight of the product was determined through GPC. The product had a number-average molecular weight of 104000 and a weight-average molecular weight of 265000.

A mixture of 153 parts by mass of water and 457 parts by mass of acetic acid was prepared as a reaction stopper, and this was cooled to −5° C., and added to the reaction mixture, taking 15 minutes. The temperature of the reaction mixture rose up to 45° C. owing to the generation of heat by hydrolysis of the acid anhydride. The reaction liquid was sampled, and the mean molecular weight of the product was determined in the same manner as that before stopping the reaction. In this stage, the product has a number-average molecular weight of 63000 and a weight-average molecular weight of 162000.

After the addition of the reaction stopper thereto, the reaction mixture was heated up to 60° C., and stirred for 1.5 hours for partial hydrolysis. This was mixed with an aqueous acetic acid solution, and the resulting polymer compound was reprecipitated, and repeatedly washed with hot water at 70 to 80° C. After dewatered, this was dipped in an aqueous 0.005 mas % calcium hydroxide solution, stirred for 30 minutes and then again dewatered. Dried at 70° C., cellulose acetate butyrate B-10 was obtained.

The thus-obtained cellulose acetate butyrate B-10 had a degree of acetyl substitution of 1.13, a degree of butyryl substitution of 1.76, an overall degree of acyl substitution of 2.89, a number-average molecular weight of 61000 and a weight-average molecular weight of 157000. A film cast from a dichloromethane solution of this sample was observed with a polarization microscope, which showed little insoluble matter.

### Comparative Example 3

### Production of Cellulose Acetate Butyrate B-11

100 parts by mass of cellulose (linter) and 180 parts by mass of acetic acid were put into a reactor equipped with a stirring device and a cooling device, and stirred at 60° C. for 4 hours to thereby activate the cellulose. 960 parts by mass of butyric anhydride and 3 parts by mass of sulfuric acid were mixed, cooled to −20° C., and then added to the reactor.

The cellulose in the reactor was esterified in such a manner that the maximum reaction temperature could be 14° C., and the acylation was stopped within the same reaction time as in Example 4. In this stage, the unreacted acylate existed in the system. The acylation was so controlled that the temperature of the reaction mixture at the acylation end pint could be 10° C. In this stage, about 10 g of the reaction solution was sampled, added to an aqueous acetic acid solution for reprecipitation, washed with warm water and dried, and the mean molecular weight of the product was determined through GPC. The product had a number-average molecular weight of 136000 and a weight-average molecular weight of 343000.

A mixture of 153 parts by mass of water and 457 parts by mass of acetic acid was prepared as a reaction stopper, and this was cooled to −5° C., and added to the reaction mixture, taking 15 minutes. The temperature of the reaction mixture rose up to 45° C. owing to the generation of heat by hydrolysis of the acid anhydride. The reaction liquid was sampled, and the mean molecular weight of the product was determined in the same manner as that before stopping the reaction. In this stage, the product has a number-average molecular weight of 108000 and a weight-average molecular weight of 284000.

After the addition of the reaction stopper thereto, the reaction mixture was heated up to 60° C., and stirred for 1.5 hours for partial hydrolysis. This was mixed with an aqueous acetic acid solution, and the resulting polymer compound was reprecipitated, and repeatedly washed with hot water at 70 to 80° C. After dewatered, this was dipped in an aqueous 0.005 mas % calcium hydroxide solution, stirred for 30 minutes and then again dewatered. Dried at 70° C., cellulose acetate butyrate B-11 was obtained.

The thus-obtained cellulose acetate butyrate B-11 had a degree of acetyl substitution of 1.13, a degree of butyryl substitution of 1.77, an overall degree of acyl substitution of 2.90, a number-average molecular weight of 104000 and a weight-average molecular weight of 277000. A film cast from a dichloromethane solution of this sample was observed with a polarization microscope, which showed much insoluble matter.

The results in Examples 1 to 5 and Comparative Examples 1 to 3 confirm the following:

Examples 1 to 4 of the invention gave cellulose acylates all having a high molecular weight and containing little insoluble matter. As opposed to these, the products in Comparative Examples 1 and 2 outside the invention contained little insoluble matter but their molecular weight was lower than that of the products of the invention. The molecular weight of the product in Comparative Example 3 was almost on the same level as that in the invention, but the product contained much insoluble matter.

The contents of Examples are discussed in more detail. According to the method of the invention where the temperature of the reaction mixture in the acylation-stopping step is controlled within a range of from −30° C. to 35° C. and a water-containing reaction stopper is added to the reaction mixture during the step, there is little or a little mean molecular weight change before and after the acylation-stopping step. On the other hand, in Comparative Examples 1 and 2 where the stopper is added with a relatively short period of time and the temperature elevation of the reaction mixture owing to the reaction heat is not positively prevented, the reduction in the mean molecular weight of the product before and after the step is remarkable. Though not clear, the reason may be because the depolymerization of the cellulose skeleton in a non-aqueous and high-temperature condition in the presence of an acid catalyst would be readily promoted. In the subsequent hydrolysis step, there occurred some reduction in the mean molecular weight of the product, but the production method of the invention where the mean molecular weight reduction is prevented in the acylation-stopping step is effective for obtaining a high-molecular-weight cellulose acylate.

The method of Comparative Example 3 is so planned that the mean molecular weight of the product before stopping the esterification could be large in consideration of the depolymerization in the reaction-stopping step. According to the method, a cellulose acylate having a high molecular weight on the same level as that in the invention could be obtained, but it contains much insoluble matter and the quality of its products is not good in comprehensive evaluation.

In Example 5, the solution after the reaction is subjected to precision filtration. The invention is sufficiently effective for reducing minor impurities, but when combined with precision filtration, the invention may exhibit a further more excellent effect.

As in the above, the invention produces a cellulose acylate having a high mean molecular weight and containing few minor impurities and suitable to optical films.

### Example 6

### Formation of Melt-Cast Film 1

(1) Preparation of Cellulose Acylate:

The samples of Examples 1 to 5 and Comparative Examples 1 to 3 were used.

(2) Pelletization:

The cellulose acylate was dried in air at 120° C. for 3 hours to have a water content of at most 0.1% by mass. The plasticizer shown in Table 1, silicon dioxide particles (Aerosil R972V) (0.05% by mass), a phosphite stabilizer 3,9-bis(octadecyloxy)-2,4,8,10-tetroxa-3,9-diphosphaspiro[5.5] undecene (0.20% by mass), a UV absorbent (a) 2,4-bis-(n-octylthio)-6-(4-hydroxy-3,5-di-tert-butylanilino) -1,3,5-triazine (0.8% by mass), and a UV absorbent (b) 2-(2′-hydroxy-3′,5′-di-tert-butylphenyl)-5-chlorobenzotriazole (0.25% by mass) were added to it, and the resulting mixture was melt-kneaded through a double-screw extruder at 190° C. The double-screw extruder was equipped with a vacuum vent, via which the extruder was degassed in vacuum [set at 0.3 atmospheres (30.3 kPa)]. In a water bath, this was extruded as strands having a diameter of 3 mm, and cut into 5-mm pellets.

(3) Melt-Cast Film Formation:

The cellulose acylate pellets prepared in the above method were dried in a vacuum drier at 100° C. for 3 hours. These cellulose acylate pellets were put into a hopper controlled at Tg −10° C., and melt-extruded through a single-screw extruder equipped with a screw having a compression ratio of 3.0, at a temperature profile mentioned below.

Screw Temperature Profile:
Upstream feed zone: 180 to 1950° C.,
Middle compression zone: 200 to 210° C.,
Downstream metering zone: 210 to 240° C.

Next, the cellulose acylate melt was led into a gear pump to remove the extruder pulsation from it, then filtered through a 3-μm filter, and cast onto a casting drum via a die at 230° C. In this step, a 3-kV electrode was set, separated from the melt by 5 cm, and the melt was electrostatically charged by 5 cm at both sides thereof. This was solidified by three casting drum rolls having a diameter of 60 cm and set at Tg −5° C., Tg and Tg −10° C. in that order to obtain a cellulose acylate film having a thickness as in Table 1. After both sides of the film were trimmed away by 5 cm, this was knurled at both sides by a width of 10 mm and a height of 50 μm. A 2000-m wound sample of each film having a width of 1.5 m was taken at a film formation speed of 30 m/min.

(4) Determination of Physical Properties of Cellulose Acylate Film:

(4-1) Minor Impurities:

After formed in a mode of melt-casting film formation of after stretched, the film sample was observed with a 100-power polarization microscope where the polarizing films were set perpendicular to each other. The number of the white impurities having a size of from 1 μm to less than 10 μm seen through the observation was visually counted, and expressed as the number of the impurities per mm².

(4-2) Determination of Re, Rth:

The film sample was conditioned at 25° C. and a relative humidity of 60% for 24 hours, and then its in-plane retardation Re and thickness-direction retardation Rth at a wavelength of 590 nm were measured.

(4-3) Coloration (Color Tone):

The coloration of the cellulose acylate film was visually observed, and evaluated by 5 ranks. Rank 1 and 2 are on an acceptable level as commercial products; rank 3 is on a level for limited application; and rank 4 and 5 are on a level unsuitable to commercial products.

(4-4) Surface Condition:

The cellulose acylate film was visually checked for step-like unevenness or die streaks, and evaluated by 5 ranks as in Table 2. Rank 1 and 2 are on an acceptable level as commercial products; rank 3 is on a level for limited application; and rank 4 and 5 are on a level unsuitable to commercial products.

(4-5) Others:

Since no solvent was used in film formation, the residual solvent amount in the cellulose acylate films obtained was all zero.

TABLE 1

| | Plasticizer | | Film | | | | | |
|---|---|---|---|---|---|---|---|---|
| Cellulose | | Amount | Thickness | Re | Rth | Minor | | Surface |
| Acylate | Type | (%) | (μm) | (nm) | (nm) | Impurities | Coloration | Condition |
| P-1 | plasticizer 1 | 5 | 85 | 2 | 5 | 0 | 1 | 1 |
| P-1 | plasticizer 2 | 7 | 95 | 4 | 8 | 0 | 1 | 1 |
| P-1 | plasticizer 3 | 7 | 78 | 3 | 4 | 0 | 1 | 1 |
| P-2 | plasticizer 2 | 5 | 103 | 2 | 4 | 1 | 1 | 1 |
| P-2 | plasticizer 2 | 9 | 83 | 4 | 2 | 0 | 1 | 1 |
| P-2 | plasticizer 2 | 15 | 95 | 0 | 1 | 1 | 1 | 1 |
| B-1 | plasticizer 1 | 5 | 122 | 3 | 4 | 2 | 1 | 1 |
| B-1 | plasticizer 2 | 7 | 74 | 1 | 5 | 2 | 1 | 1 |
| B-1 | plasticizer 3 | 7 | 88 | 5 | 7 | 1 | 1 | 1 |
| B-2 | plasticizer 3 | 7 | 95 | 2 | 3 | 2 | 1 | 1 |
| B-2 | plasticizer 3 | 9 | 93 | 5 | 9 | 1 | 1 | 1 |
| B-2 | plasticizer 3 | 12 | 79 | 3 | 4 | 1 | 1 | 1 |
| P-3 | plasticizer 1 | 5 | 83 | 2 | 4 | 0 | 1 | 1 |
| P-3 | plasticizer 2 | 5 | 82 | 1 | 3 | 0 | 1 | 1 |
| P-10 | plasticizer 2 | 7 | 72 | 2 | 5 | 1 | 1 | 2 |
| B-10 | plasticizer 2 | 7 | 89 | 5 | 9 | 2 | 1 | 3 |
| B-11 | plasticizer 2 | 7 | 95 | 2 | 5 | 93 | 1 | 4 |

Plasticizer 1: Biphenyldiphenyl phosphate
Plasticizer 2: Dioctyl adipate
Plasticizer 3: Glycerin diacetate monooleate

The films produced from the cellulose acylate according to the production method of the invention contain few minor impurities and have a good surface condition with neither die streaks nor step-like unevenness. As opposed to these, the films produced from the cellulose acylate not according to the production method of the invention are not good for commercial products in point of their quality in that their surface condition is poor or they contain many minor impurities

### Example 7

### Formation of Melt-Cast Film 2

(1) Preparation of Cellulose Acylate:

The samples of Examples 1 to 5 and Comparative Examples 1 to 3 were used.

(2) Pelletization of Cellulose Acylate:

80 parts by weight of the above cellulose acylate, 20 parts by weight of a powder prepared by grinding a cellulose acylate film mentioned below, and 0.3 parts by weight of a stabilizer (Sumitomo Chemical's Sumilizer GP) were mixed. The mixture was dried at 100° C. for 3 hours to have a water content of at most 0.1% by mass, then melt-kneaded through a double-screw extruder at 180° C. and extrude out into hot water at 60° C. as strands, and cut into disc pellets having a diameter of 3 mm and a length of 5 mm.

(3) Melt-Cast Film Formation:

The above pellets were dried with demoisturized air having a dew point of −40° C., at 100° C. for 5 hours to have a water content of at most 0.01% by mass, then fed into a hopper of a single-screw melt-kneading extruder at 80° C., and melted in the extruder having a controlled inlet port temperature of 180° C. and a controlled outlet port temperature of 230° C. The diameter of the screw in the extruder was 60 mm; L/D=50; and the compression ratio was 4. The resin thus extruded out through the melt extruder was metered with a gear pump, via which a predetermined amount of the resin melt was fed out. In this stage, the revolution number of the extruder was so controlled that the resin pressure before the gear pump could be constantly 10 MPa. The resin melt thus fed out through the gear pump was filtered through a leaf disc filter having a filtration precision of 5 μm. Then, after led to pass through a static mixer, the melt (cellulose acylate melt) was extruded out onto a casting drum (CD) via a hunger coat die having a slit distance of 0.8 mm at 230° C. This was extruded out onto a series of three casting rolls set at Tg −5° C., Tg and Tg −10° C. (Tg is a glass transition temperature of the polymer melt) in that order, and a tough roll was kept in contact with the casting roll on the most upstream side under a pressure of 1.5 MPa. The touch roll used herein is one (double-pressure roll) described in Example 1 in JP-A-11-235747, and this was conditioned at Tg −5° C. (however, the thickness of the thin-walled metal jacket was 3 mm). The “pressure” applied to the touch roll is a value obtained by dividing the load applied to the touch roll by the contact area between the touch roll and the casting roll.

The solidified melt was peeled off from the casting drum, and its both sides were trimmed off (by 5% of the overall width thereof) just before wound up. The trimmed wastes were cut into 0.5-cm² pieces, and re-melted and recycled as the film material in the above pelletization.

After trimmed, the film was knurled at both sides by a width of 10 mm and a height of 50 μm, and processed at 30 m/min to obtain an unstretched film having a width of 1.5 m and a length of 3000 m. The film was analyzed for its residual solvent amount according to the above-mentioned method, but no residual solvent was detected therein. Tg of the film was determined through DSC as follows: 20 mg of the sample to be analyzed was put into the pan for DSC, heated in a nitrogen atmosphere at a rate of 10° C./min from 30° C. up to 250° C., and then cooled to 30° C. at a rate of −10° C./min. Then, this was again heated from 30° C. up to 250° C., and the temperature at which the base line of the temperature profile of the sample begins to deviate from the low-temperature side is referred to as the glass transition temperature (Tg) of the sample.

(4) Evaluation of Film:

In the same manner as that for Example 6, the physical properties of the film were determined. Also in this Example, the films obtained from the cellulose acylate produced according to the production method of the invention had few minor impurities and had neither die streaks nor step-like unevenness on the film surface, and their surface condition was all good.

### Example 8

### Formation of Solution-Cast Film

Solution-Casting Film Formation of Mixed Cellulose Acylate:

The samples of Examples 1 to 5 and Comparative Examples 1 to 3 were used. 100 g of the sample was dissolved in 600 mL of methylene chloride/methanol (9/1) solution. The resulting polymer solution (dope) was cast with a doctor blade onto a SUS plate kept cooled at 15° C., and dried thereon at 25° C. for 30 minutes. The formed film was peeled off from the support at a speed of 200 mm/sec. In this step, the peeling residue on the support was visually determined. In case where no residual film was found on the support after the film peeling from it, then the result is “no”; in case where some residual film was found thereon, then the result is “yes”; and in case where some but a trace residual film was found thereon, the result is “yes (but trace)”. This was dried at 100° C. for 10 minute and then at 133° C. for 30 minutes to obtain a transparent film. The film was checked for minor polarizing impurities in the same manner as in Example 5. The results are shown in Table 2.

TABLE 2

| | Film | | | Minor | | |
|---|---|---|---|---|---|---|
| Cellulose | thickness | Re | Rth | Impuri- | Film Residue | Surface |
| Acylate | (μm) | (nm) | (nm) | ties | after peeling | Condition |
| P-1 | 75 | 4 | 35 | 0 | no | 1 |
| P-2 | 69 | 7 | 32 | 0 | no | 1 |
| B-1 | 94 | 4 | 31 | 1 | no | 1 |
| B-2 | 88 | 2 | 29 | 0 | no | 1 |
| P-3 | 86 | 2 | 36 | 0 | no | 1 |
| P-3 | 80 | 3 | 32 | 0 | no | 1 |
| P-10 | 91 | 11 | 56 | 1 | yes | 2 |
| B-10 | 77 | 18 | 73 | 1 | yes | 3 |
| B-11 | 74 | 9 | 52 | 74 | yes | 4 |
| | | | | | (but trace) | |

The films produced from the cellulose acylate according to the production method of the invention contain few minor impurities and have a good surface condition with neither die streaks nor step-like unevenness since they are smoothly peeled from the support. As opposed to these, the films produced from the cellulose acylate not according to the production method of the invention are not good for commercial products in point of their quality in that their peelability is not good and therefore their surfaces are roughened or they contain many minor impurities.

### Example 9

### Formation of Polarizer, Image Display Device,

### Low-Reflection Film, and Optically-Compensatory Film

(1) Saponification of Cellulose Acylate Film:

The cellulose acylate films formed in Examples 6 to 8 were saponified according to a dipping saponification method mentioned below. In this method, an aqueous NaOH solution (2.5 mol/L) was used as a saponifying liquid. This was conditioned at 60° C., and the cellulose acylate film was dipped therein for 2 minutes. Next, the film was dipped in an aqueous sulfuric acid solution (0.05 mol/L) for 30 seconds, and then washed with water.

(2) Formation of Polarizer:

According to Example 1 in JP-A-2001-141926, the film was stretched in the machine direction between two pairs of nip rolls rotating at a different peripheral speed, thereby producing a polarizing film having a thickness of 20 μm.

(3) Lamination:

Thus obtained, the polarizing film was laminated with any of the saponified or unstretched cellulose acylate film or a saponified FUJITAC (unstretched triacetate film) in the following combination, using an aqueous 3% PVA (Kuraray's PVA-117H) solution as an adhesive, in such a manner that the stretching direction of the polarizing film could be in parallel to the traveling direction (machine direction) of the cellulose acylate film.

Polarizer A: unstretched cellulose acylate film/polarizing film/FUJITAC TD80U,

Polarizer B: unstretched cellulose acylate film/unstretched cellulose acylate film.

(4) Package Test in Image Display Device:

26-inch and 40-inch liquid-crystal devices with a VA-mode liquid-crystal cell (by Sharp) therein were restructured as follows: Of two pairs of polarizers as disposed to be on both sides of the liquid-crystal layer therein, one polarizer on the viewers' side was peeled off, and in place of it, the above polarizer A or B was stuck to the structure with an adhesive. The polarizers were so disposed that the transmission axis of the polarizer on the viewers' side could be perpendicular to the transmission axis of the polarizer on the backlight side, and the liquid-crystal display device was thus restructured. Thus restructured, the liquid-crystal display device was put on and tested for the light leakage, the color unevenness and the in-plane non-uniformity at the time of black level of display. The cellulose acylate film of the invention caused neither light leakage nor color unevenness, and its properties were good. In addition, the cellulose acylate film caused no color change in the device and was extremely excellent.

(5) Formation of Low-Reflection Film:

According to Example 47 in Hatsumei Kyokai Disclosure Bulletin (No. 2001-1745, published on Mar. 15, 2001 by the Hatsumei Kyokai), the cellulose acylate film of the invention was formed into a low-reflection film, and it showed good optical properties.

(6) Formation of Optically-Compensatory Film:

According to Example 1 in JP-A-11-316378, the cellulose acylate film of the invention was coated with a liquid-crystal layer, and a good optically-compensatory film was obtained.

As described in detail with reference to its preferred embodiments, the production method of the invention may give a cellulose acylate having a high mean molecular weight and containing few minor impurities. The cellulose acylate may be formed into films suitable for optical applications. Accordingly, the invention provides a high-quality polarizer, retardation film, optical film and liquid-crystal display device. Therefore, the industrial applicability of the invention is good.

The present disclosure relates to the subject matter contained in Japanese Patent Application No. 306513/2005 filed on Oct. 21, 2005 and Japanese Patent Application No. 208738/2006 filed on Jul. 31, 2006, which are expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for producing a cellulose acylate satisfying the following formulae (1) to (3), which comprises:
1) acylating cellulose with an esterifying agent that contains an excessive amount of an acid anhydride relative to the hydroxyl group of cellulose (acylation step), and then
2) mixing the reaction mixture with a water-containing reaction stopper to thereby hydrolyze the acid anhydride while controlling the temperature of the reaction mixture to fall between −30° C. and 35° C. (acylation-stopping step):
2.0≦A+B≦3 (1),
0≦A≦2.9 (2),
0.1≦B≦3 (3),
wherein A means a substitution degree for an acetyl group, and B means a total substitution degree for acyl groups having from 3 to 9 carbon atoms.

2. The method for producing a cellulose acylate according to claim 1, wherein the number-average molecular weight by GPC of the cellulose acylate is from 40000 to 500000.

3. The method for producing a cellulose acylate according to claim 1, wherein the number-average molecular weight by GPC of the cellulose acylate is from 60000 to 300000.

4. The method for producing a cellulose acylate according to claim 1, wherein the number-average molecular weight by GPC of the cellulose acylate is from 85000 to 300000.

5. The method for producing a cellulose acylate according to claim 1, wherein the temperature of the reaction mixture is controlled to fall between −20° C. and 30° C. in the acylation-stopping step.

6. The method for producing a cellulose acylate according to claim 1, wherein the reaction stopper is mixed, taking from 3 minutes to 3 hours, in the acylation-stopping step.

7. The method for producing a cellulose acylate according to claim 1, wherein the reaction stopper is an aqueous solution of a carboxylic acid having from 2 to 4 carbon atoms, which contains from 5% by mass to 80% by mass of water.

8. The method for producing a cellulose acylate according to claim 1, wherein the cellulose acylate has a propionyl group or a butyryl group as the acyl group having from 3 to 9 carbon atoms.

9. The method for producing a cellulose acylate according to claim 1, wherein the ultimate temperature in the acylation step is from 10° C. to lower than 25° C.

10. A cellulose acylate film formed of the cellulose acylate produced according to the production method of claim 1.

11. The cellulose acylate film according to claim 10, which has a residual solvent content of at most 0.01% by mass.

12. The cellulose acylate film according to claim 10, which is formed through solution-casting film formation.

13. The cellulose acylate film according to claim 10, which is formed through melt-casting film formation.

14. The cellulose acylate film according to claim 10, wherein the in-plane retardation (Re) and the thickness-direction retardation (Rth) of the film satisfy the following formulae (4) and (5):
0 nm≦Re≦300 nm (4),
−200 nm≦Rth≦500 nm (5).

15. A polarizer comprising a polarizing film and a protective film, wherein the protective film is the cellulose acylate film according to claim 1.

16. A retardation film comprising the cellulose acylate film of claim 1.

17. An optical film having, on the cellulose acylate film according to claim 1, an optically-anisotropic layer that contains an aligned liquid-crystalline compound.

18. An image display device comprising the cellulose acylate film according to claim 1.
